(19) United States
(12) Patent Application Publication
(10) Pub. No.: US 2004/0140975 A1
(43) Pub. Date: Jul. 22, 2004

(54) Service providing system and device or method or recording medium or program regarding the system

(75) Inventors: Asako Saito, Tokyo (JP); Daisuke Iino, Funabashi-shi (JP); Kenichi Fujita, Yokohama-shi (JP)

Correspondence Address: BROWDY AND NEIMARK, P.L.L.C., 624 NINTH STREET, NW, SUITE 300, WASHINGTON, DC, 20001-5303, US

(73) Assignee: MATSUSHITA ELECTRIC INDUSTRIAL CO., LTD., Osaka (JP)

(21) Appl. No.: 10/687,932

(22) Filed: Oct. 20, 2003

(30) Foreign Application Priority Data
Oct. 18, 2002 (JP) P2002-304790

(51) Int. Cl. G06T 1/00

(52) U.S. Cl. 345/418

(57) ABSTRACT

The present invention relates to a display device for displaying information provided with functions, for instance, for purchasing and using electronic contents such as electronic books and music, and is intended to provide a display device enabling its user, if he or she wants to use an electronic content while going out, to process the purchase of and use any electronic content on a shop rack in a storage medium stored in advance in the display device. A display device according to the invention having a screen for displaying a user rack for presenting purchased contents and a shop rack for presenting unpurchased contents is provided with an input unit for accepting user operations on any of the contents on the user rack or the shop rack which is displayed, a rack function executing unit for processing any user operation accepted by the input unit, an account settlement managing unit for managing a purchase history and a return history, a rack display executing unit for displaying a screen of the shop rack and the user rack, and a content reproducing unit for reproducing contents.

### BACKGROUND OF THE INVENTION

1. Field of the Invention

The present invention relates to a display device for displaying a list of contents provided with, for instance, functions for purchasing and returning electronic contents such as electronic books, music and animations, and more particularly a display device enabling its user, if he or she wants to use an electronic content while going out, to process the purchase of and use any electronic content on a shop rack in a storage medium stored in advance in the display device.

2. Description of the Prior Art

Portable devices often used today when their users are out include, for music lovers for instance, CD players, MD players and MP3 players. Listening to music is not the only purpose for which such portable devices are used, but laptop personal computers and reproduction devices including PDAs are also used nowadays for accessing electronic books.

Underlying this trend is the circumstance that those contents which have traditionally been distributed in the form of printed paper sheets, CDs and other tangible media through book stores and record shops are now also distributed in the form of digital files along with the rapid dissemination of high speed Internet lines including ADSL, cable TV and optical fiber cables.

This extensive availability of high speed Internet lines and the environment of all-time connection has facilitated downloading of large volume contents in megabytes (MBs) into personal computers and STBs now found in many ordinary households.

In terms of the distribution of musical contents in particular, they now can be sold piece by piece, which previously cost too much for commercial distribution, not in sets of several pieces. Music lovers can choose and buy only the particular pieces they want to listen to.

These circumstances including the developed infrastructures for the distribution of electronic contents and the expanded choice for users are resulting in a gradual increase in the variety and quantity of available electronic contents, and a further dramatic increase is expected.

To look at the way electronic contents are used, at present the user has to complete the purchase of the desired content by the time he or she has acquired its possession, irrespective of whether the file is downloaded from the Internet or the CD is bought at a retail store, and only then the user can transfer it to a memory built into a portable CD player or a detachable storage medium so that the content can be read or listened to while the user is going out.

In other words, the user has to choose and buy the contents in advance he or she wants to play back on the portable player.

This “choose . . . in advance” may also include automatic choice of 10 pieces a month under a contract for monthly supply.

Therefore, when using an electronic content on a portable player or the like, the prior art permits only the use of an already purchased content as pointed out above.

For this reason, the user has to choose and buy the desired content before actually using it and, if the use of another content is desired, the earlier installed content will have to be replaced with the new one.

This way of use necessitates preparations for the use of a content, resulting in a constraint that some time has to be spent in a specific place. This time and trouble taken are perceived by many users as inconveniences, and this unfavorable perception seems to have considerable adverse impact on the frequency of renewing the content, and accordingly the frequency of purchases.

Thus, the conventional way in which electronic contents are used involve disadvantages for both their users and providers, and the developed infrastructures for their use may fail to be fully utilized and lead to a vicious circle of a decrease in purchase volume and a decrease in the variety of available contents.

### SUMMARY OF THE INVENTION

An object of the present invention, attempted to solve the problem noted above, is to eliminate the trouble which the user would otherwise have to take in use of an electronic content and to provide a display device in whose storage area unpurchased contents can be stored and which has a function to allow its user to choose and use any desired one of the stored contents while he or she is going out. The storage area in this content may be a memory area built into the display device, a detachable semiconductor memory, or an optical disk such as a CD or a DVD. It is presupposed that the unpurchased contents stored in the storage area are automatically stored.

Incidentally, the capacity of storage media per unit is increasing every year, and their per-unit price is decreasing. Therefore, even if unpurchased contents are stored in a storage medium, their impact is likely to be too small to affect the area in which other contents already purchased by the user are stored.

In order to solve the problem noted above, a display device according to the invention has purchased contents and unpurchased contents, further has a screen for displaying a user rack for presenting the purchased contents and a shop rack for presenting the unpurchased contents, and is provided with an input unit for accepting user operations on any of the contents on the user rack or the shop rack which is displayed, a rack function executing unit for processing any user operation accepted by the input unit, an account settlement managing unit for managing a purchase history and a return history, a rack display executing unit for displaying a screen of the shop rack and the user rack, and a content reproducing unit for reproducing contents. This configuration enables the user to operate the display device to use, buy or return electronic contents.

Thus, not only can purchased contents be used but also can any unpurchased content be bought and used when its use is desired. At a mobile information terminal, any one of unpurchased contents stored in a storage medium in advance can be selected, bought and used whenever and wherever its use is desired. Moreover, by managing the state of utilization of contents, it is made possible to permit returning of any unpurchased one. By recording the state of access to contents, it is made possible to permit returning, which is prohibitively difficult for contents distributed in the conventional forms of printed paper sheets or CDs, and the barrier to users' purchases of contents is thereby lowered.

The object and advantages of the present invention will become more apparent from the following detailed description of preferred embodiments thereof when taken in conjunction with the accompanying drawings.

### BRIEF DESCRIPTION OF THE DRAWINGS

FIG. 1 is a block diagram showing the configuration of a display device, which is a first preferred embodiment of the invention;

FIG. 2 illustrates an example of bookshelf information;

FIG. 3 illustrates an example of book information;

FIG. 4 illustrates an example of bibliographical information;

FIG. 5 illustrates an example of a purchase history;

FIG. 6 illustrates an example of access state information;

FIG. 7 illustrate examples of a book cover;

FIG. 8 illustrate examples of bookshelf display screen;

FIG. 9 illustrates an example of periodicals rack display screen;

FIG. 10 illustrates an example of new arrivals display screen;

FIG. 11 illustrates an example of bibliographical information display screen;

FIG. 12 illustrates an example of preview display screen;

FIG. 13 illustrates an example of full size preview display screen;

FIG. 14 illustrates an example of automatic bookshelf presentation screen;

FIG. 15 illustrates an example of imaged purchase operation;

FIG. 16 illustrate an example of bookshelf information before and after a purchase;

FIG. 17 illustrates an example of rack display screen when one of the books on the ordered book shelf has arrived;

FIG. 18 illustrates an example of book cover display screen when one of the books on the ordered book shelf has arrived;

FIG. 19 illustrates an example of indication for an unreleased book on the ordered book shelf;

FIG. 20 illustrate an example of access screen for unpaid and paid books;

FIG. 21 illustrates an example of access display screen;

FIG. 22 illustrates an example of book locating screen;

FIG. 23 illustrates an example of access state display screen;

FIG. 24 illustrates an example of password input display screen at the time of access;

FIG. 25 illustrates an example of related information display screen;

FIG. 26 illustrates an example of return confirmation display screen;

FIG. 27 illustrates an example of function stop screen;

FIG. 28 is a flowchart of the input unit;

FIG. 29 is a purchase flowchart of the rack function executing unit;

FIG. 30 is a return flowchart of the rack function executing unit;

FIG. 31 is a bibliographical information display flowchart of the rack function executing unit;

FIG. 32 is a preview display flowchart of the content reproducing unit;

FIG. 33 is a book access flowchart of the content reproducing unit;

FIG. 34 illustrate an example of account settling management information before and after a purchase;

FIG. 35 is a block diagram showing the configuration of a display device, which is a second preferred embodiment of the invention;

FIG. 36 is a flowchart at the time of bookshelf displaying;

FIG. 37 is a flowchart at the time of bibliographical information displaying;

FIG. 38 is a flowchart at the time of automatic bookshelf presentation;

FIG. 39 is a flowchart at the time of accessing a book;

FIG. 40 is a block diagram showing the configuration of a service providing system, which is a third preferred embodiment of the invention; and

FIG. 41 illustrate an image of page turning forward and backward operations.

### DESCRIPTION OF THE PREFERRED EMBODIMENTS

(First Embodiment)

A display device for accessing electronic books will be described below as a mode of implementing the invention of display devices set forth in claims 1 through 14.

FIG. 1 is a block diagram showing the configuration of a display device for accessing electronic books, which is a first preferred embodiment of the invention.

The display device comprises an input unit (101) for accepting a user operation on electronic books on a displayed user rack or shop rack, a rack function executing unit (102) for processing a user operation accepted by the input unit, an account settlement managing unit (103) for managing the purchase history and the return history, a rack display executing unit (104) for displaying shop rack and user rack screens, and a content reproducing unit (105) for accessing and reproducing an electronic book.

As will be described in more detail afterwards, bookshelf information, book information, bibliographical information needed for the use of any electronic book are stored in a storage medium (106), such as a detachable optical disk, a semiconductor memory card or a hard disk drive or a semiconductor memory built into the display device.

Whether or not the storage medium is detachable is irrelevant to the essentials of the present invention.

The display device may be a PDA or a dedicated terminal provided with a display unit capable of displaying double spread pages at the same time.

On bookshelves, books are grouped by category, such as the genre or the price range. For instance, there is a new issue shelf, on which only new issues including newspapers are arranged, and a literature/review shelf, on which novels and other literary works are arranged.

Depending on the number of books belonging to a category, a bookshelf may have sub-shelves. For instance, the new issue shelf may further have within itself a newspaper sub-shelf, a weekly sub-shelf and so forth.

A bookshelf comprises a shop rack and a user rack on which purchased books are arranged. Books on the shop rack become accessible after their purchase is processed.

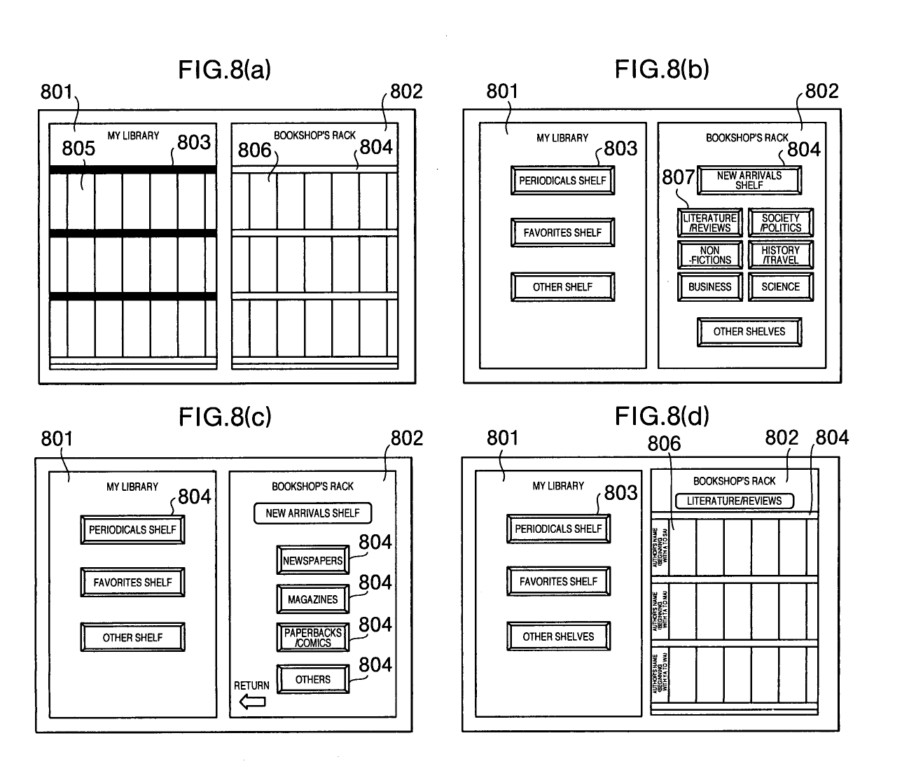

FIG. 8a) shows an image of display screen shown when power supply is turned ON.

In the right part of the screen is shown a shop rack (802) and in the left part, a user rack (801) (FIG. 8a) display example 1). The user can execute such operations as moving the bookshelf and selecting a book by use of a touch panel or a cross key button provided on the box of the display device.

The following description will refer to the display device on a function-by-function basis.

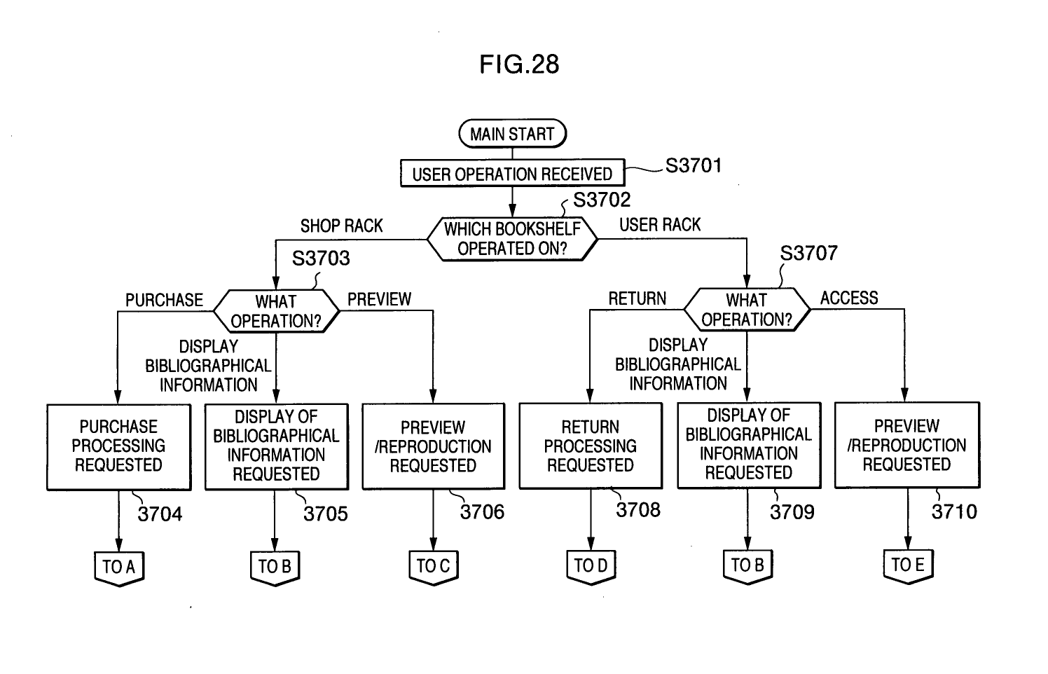

First will be described an internal processing flow in the input unit (101) with reference to FIG. 28.

The input unit (101), when it receives an operation on the shop rack or user rack screen shown on the display unit of the display device (step S3701), determines whether the book to be operated upon is on the shop rack or on the user rack (step S3702). If it is a book on the shop rack, the input unit (101) determines how it is required to be operated (step S3703), and requests either the rack function executing unit (102) or the content reproducing unit (105) for processing depending on the determination.

If the operation demands a purchase, the rack function executing unit (102) will be requested to process the purchase (step S3704).

If it demands displaying of bibliographical information, the rack function executing unit (102) will be requested to display bibliographical information (step S3705).

If it demands preview and reproduction of a book, the content reproducing unit (105) will be requested to let the book be previewed and reproduced (step S3706).

On the other hand, if the determination at step S3702 indicates a book on the user rack, similarly the processing demanded by the operation will be identified (step S3707), and the rack function executing unit (102) and the content reproducing unit (105) will be requested for processing according to the identified demand.

If the operation demands a return, the rack function executing unit (102) will be requested to process a return (step S3708).

If it demands displaying of bibliographical information, the rack function executing unit (102) will be requested to display bibliographical information (step S3709).

If it demands access to a book, the content reproducing unit (105) will be requested to reproduce the book (step S3710).

Step S3704 to step S3710 of processing will be individually described below.

(1) Book Purchasing Function

Book purchasing can be accomplished by a user operation on the shop rack screen.

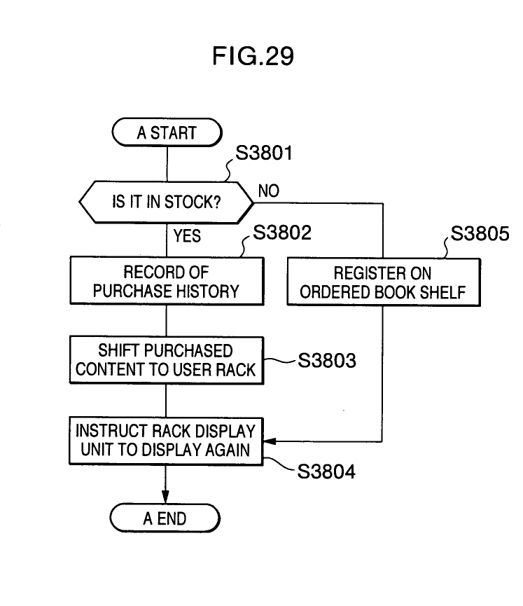

The flow of book purchase flow after the rack function executing unit (102) has received the request from the input unit (101) for purchase processing (step S3704) will be described with reference to FIG. 29.

The rack function executing unit (102) first checks, in order to determine whether or not the book whose purchase is demanded can be immediately reproduced, whether or not pertinent book information is on the storage medium (step S3801). Further description will be made on book information afterwards.

If the determination reveals the presence of the book, the account settlement managing unit (103) is requested to record the pertinent purchase history (step S3802). Next, to shift the purchased book to the user rack, bookshelf information in the storage medium is rewritten (step S3803). After that, the rack display executing unit (104) is requested to display the user rack or the shop rack again (step S3804).

Or if the determination at step S3801 reveals the absence of book information on the storage medium, the book is registered on the ordered book shelf in the bookshelf information in the storage medium (step S3805), and step S3804 is executed.

The book information is intended for use in managing files, which are the substances of electronic books, and includes, for instance as shown in FIG. 3, a book ID (301) for identifying a given book, a return condition (302) stating the condition of returning the book and a book text (303). The return condition will be explained afterwards in connection with the description of the function to return a book.

The book text is a file configured of texts and/or images, and its format may be either an image file, a text file such as HTML or a unique format such as PDF.

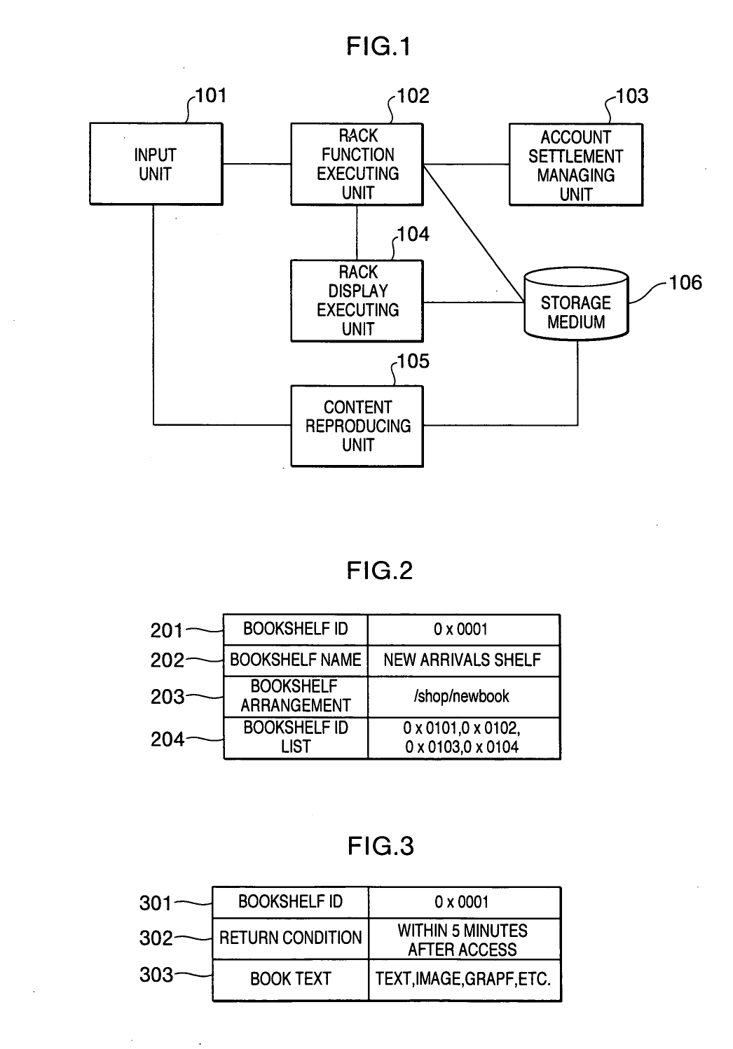

The bookshelf information is necessary information for displaying a bookshelf and comprises, for instance as shown in FIG. 2, a bookshelf ID (201) for identifying a given bookshelf, a bookshelf name (202) for indicating the category of the bookshelf, information (203) indicating the arrangement of the bookshelf, and a list (204) of books placed on the bookshelf.

The information (203) indicating the arrangement of the bookshelf in a directory structure to show whether a given bookshelf is part of the shop rack or part of the user rack; a bookshelf beginning with “/shop” belongs to the shop rack and a bookshelf beginning with “/user” belongs to the user rack.

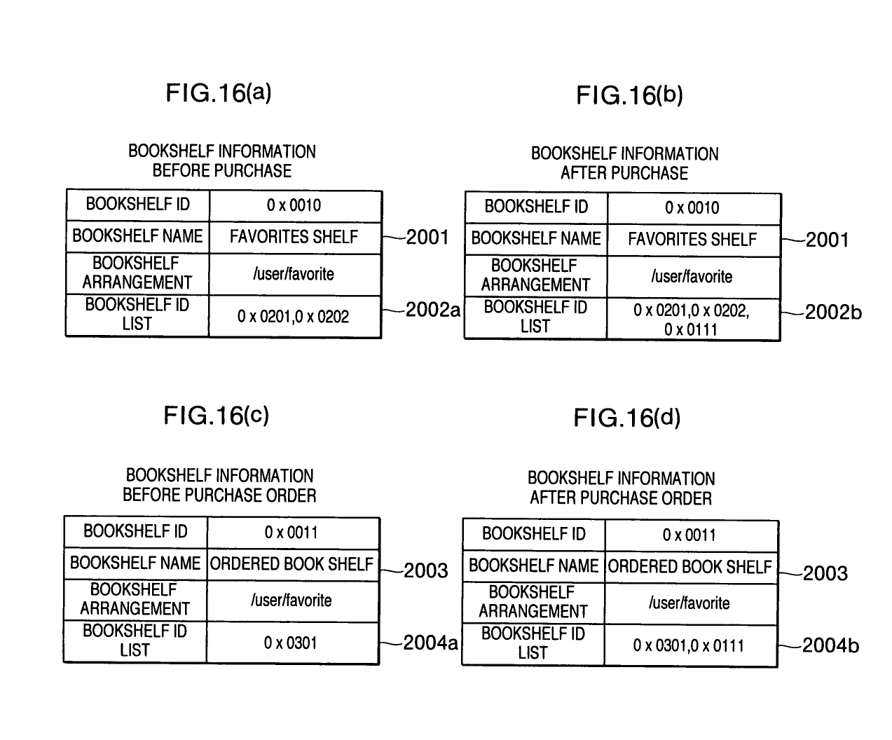

Data variations due to the registration of bookshelf information done at step S3803 and step S3805 are shown in FIG. 16.

For instance, if a book whose book ID is 1x0111 has been bought and that book is to be placed on a favorites shelf (2001) at step S3803, the book will be added to the book ID list of the favorites shelf (2001) (2002a before purchase and 2002b after purchase).

Further at step S3805, as the book is placed on the ordered book shelf (2003), similarly the book ID of that book is added to the book ID list (2004a before purchase and 2004b after purchase).

Although the ordered book shelf is arranged on the user rack here as an example, it may as well be arranged on the shop rack.

The book placed on the ordered book shelf is stored into the storage medium at the time of updating the information in the storage medium and, in response to a user operation to purchase it, steps S3802 through S3804 are executed.

The data structure of the purchase history to be recorded at step S3802 is shown in FIG. 5. The purchase history contains the book ID (301) for identifying the book, classification information (502) indicating whether the book is to be bought or returned, and a date (503).

This purchase history is delivered to an account settlement processing server responsible for account settlement when communication with the account settlement processing server has become possible. The means and method of communicating with the account settlement processing server are not described here because they are irrelevant to the essentials of the invention. The display device has a function to transmit purchase histories.

Because of this capability for processing of purchases within the display device, the user can select and access a desired book even while he or she is going out.

(2) Return Function

A user operation for returning a book once purchased is possible on the user rack screen.

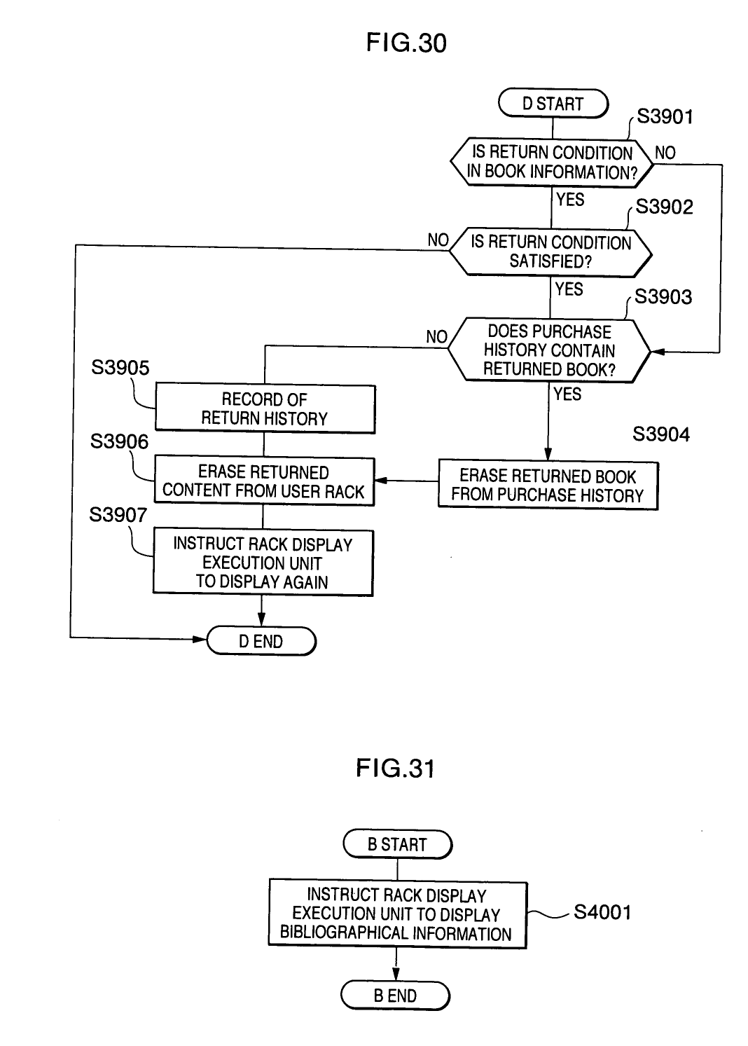

The flow of book return processing after the rack function executing unit (102) has received a return processing request from the input unit (101) (step S3708) will be described with reference to FIG. 30.

The rack function executing unit (102) first references book information in the storage medium to find out whether or not a return condition is attached to the book whose return is demanded (step S3901). If the book information includes a provision for any return condition, it will be determined that a return condition is attached to the book.

Next it is determined whether or not the book to be returned satisfies the return condition (step S3902).

If it is found that the condition is satisfied at step S3902, i.e. the book can be returned, a purchase history managed by the account settlement managing unit (103) will be referenced to find out whether or not the book has a purchase history (step S3903).

If the determination reveals the existence of a purchase history of the book, that purchase history will be erased (step S3904), further the pertinent book ID will be removed from the book ID list in the bookshelf information of the user rack in the storage medium (step S3906), and the rack display executing unit (104) will be requested to display the shelf again (step S3907)

If the determination at step S3903 reveals the absence of any purchase history of the book, i.e. that the purchase history has already been submitted to the account settlement processing server, the return history will be added to the purchase history (step S3905). The return history is similar to the purchase history in all other respects than the classification (502), which is a return in the return history.

After that, step S3906 and step S3907 are executed.

If no return condition is found in the book information at step S3901, the processing will go ahead to step S3903.

If the book desired to be returned is found not satisfying the return condition at step S3902, the processing will be discontinued.

Upon completion of the return processing, the returned book disappears from the user rack in the view of the user, making it no longer possible to access the book after its return.

The return condition (302) contained in the book information may be, for instance, that it is within a certain period after the purchase or after the access, or that the accessed pages are no more than a prescribed extent.

The access state of the book to be compared with the return condition exists on the storage medium as access state information, which is registered by the rack function executing unit (102) at the time of purchase, and subsequently updated by the content reproducing unit (105) on every occasion of reproduction.

The data structure of the access state information is shown in FIG. 6.

The access state information includes the book ID (301) for identifying the book, and information on purchase day/hours (602) indicating when the book was bought, access start day/hours (603) indicating when the access and reproduction were started, last access day/hours (604) indicating when the access and reproduction were last done, the previously accessed page (605) indicating the page number where the previous access and reproduction ended, and the last accessed page (606) indicating the last page number of the past access and reproduction ever reached.

To note separately, when the user accesses a book, the content reproducing unit (105) also records the access start day/hours (603), the last access day/hours (604), the previously accessed page (605) and the last accessed page (606) of the accessed book.

When, for instance, the user operates to return book A and the return condition of book A is “within one hour after purchase”, if the purchase day/hours in the access state information on book managed by the content reproducing unit (105) is not more than one hour before the day/hours of the desired return, the book will be determined returnable or, if more than one hour has passed, it will be determined no longer returnable.

Or, similarly, when the return condition of book A is “within one hour after access”, if the access start day/hours in the access state information on book managed by the content reproducing unit (105) is not more than one hour before the day/hours of the desired return, the book will be determined returnable or, if more than one hour has passed, it will be determined no longer returnable.

Or, similarly, when the return condition of book A is “within 10 pages”, if the last accessed page the access state information on book managed by the content reproducing unit (105) is no farther than page 10, the book will be determined returnable or, if more than 10 pages have been accessed, it will be determined no longer returnable.

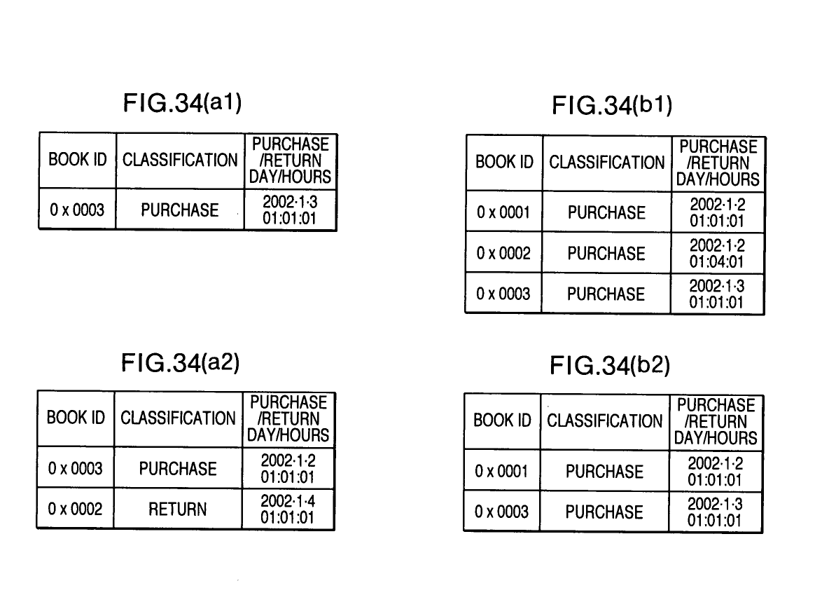

FIG. 34 show items of the purchase history before and after a return.

For instance, when a previously purchased book of 0x0002 in book ID is to be returned, if there is no purchase history (a1), a return history of the book ID 0x0002 will be added (a2) (step S3905).

Or if there is a purchase history of the book (b1), the purchase history of the book ID 0x0002 will be erased (b2) (step S3904).

A book bought at a conventional bookstore or the like has a tangible substance of printed paper, and it is impossible to determine how much of it has been accessed.

Therefore, for a conventional book, its return has not been accepted as a normal commercial practice unless there is some problem in the book itself or on the part of the vendor.

For an electronic book, on the other hand, as it is possible to detect whether or not it has been accessed and, if it has been, how much of it has been accessed, this information can be used to determine whether or not to accept a return for a reason on the user's part.

(3) Bibliographical Information Display Function

It is enabled to display bibliographical information by selecting the pertinent book by a user operation from the user rack or the shop rack screen.

The flow of bibliographical information displaying after the rack function executing unit (102) has received from the input unit (101) a request for displaying bibliographical information (step S3705 and step S3709) will be described with reference to FIG. 31.

The rack function executing unit (102) requests the rack display executing unit (104) to display bibliographical information (step S4001).

The rack display executing unit (104), requested to display bibliographical information, displays bibliographical information on the screen.

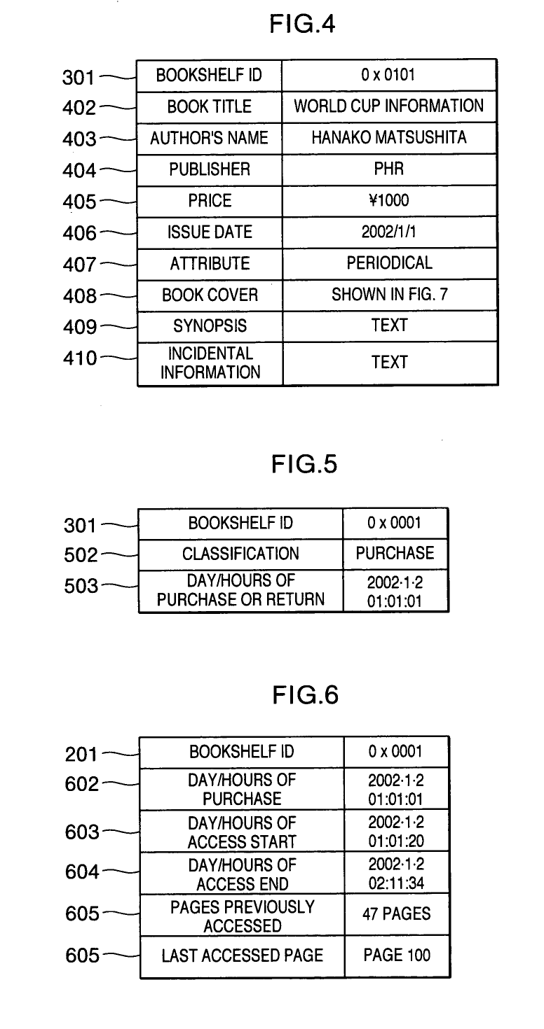

FIG. 4 shows bibliographical information.

Bibliographical information, present on the storage medium, includes the book ID (301), book's title (402), author's name (403), publisher (404), price (405) and issue date (406) for identifying the book, together with such items of information for identifying the bookshelf as an attribute (407), book cover (408), synopsis (409) and incidental information (410).

(4) Preview Function

It is further possible to switch the display on the shop rack screen between bibliographical information and a preview. For instance, if the user switches the display when referencing bibliographical information, a preview screen can be displayed where bibliographical information has been displayed.

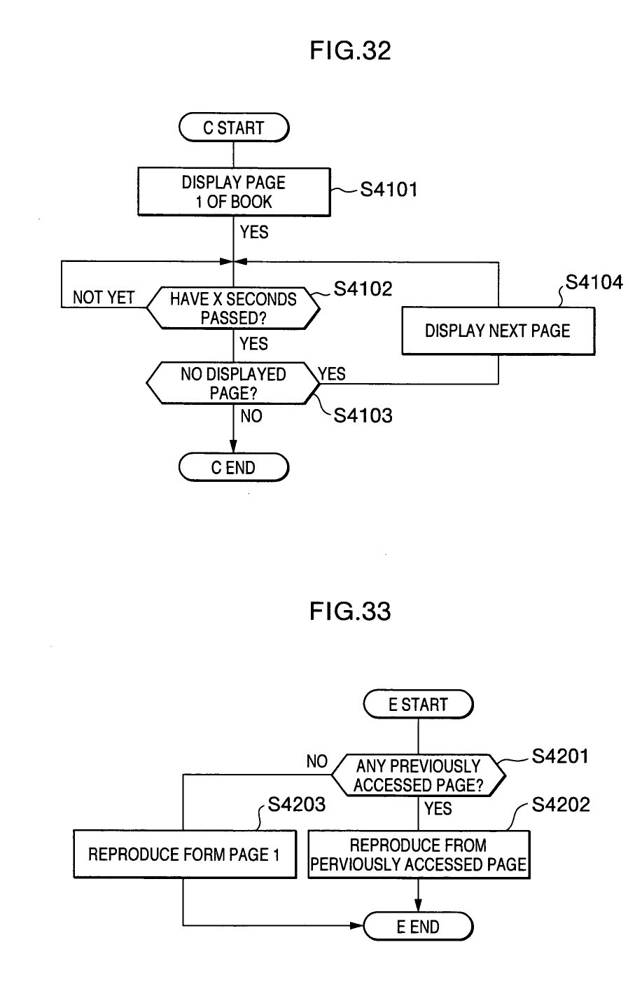

The preview reproduction flow after the content reproducing unit (105) has received from the input unit (101) a request for preview reproduction (step S3710) will be described below with reference to FIG. 32. The content reproducing unit (105) first displays page 1 of the book (step S4101).

Next, the lapse of X seconds is awaited (step S4102). After the X seconds, it is determined whether or not the displayed page is the final page (step S4103) and, if it is not the final page, the next page will be displayed (step S4104). After that, the processing from step S4102 through step S4104 is repeated until the final page comes.

The preview reproduction is accomplished by use of the text of book information.

The content reproducing unit, having a timer function inside, can count for a certain period after one page is displayed. The X seconds are predetermined. If, for instance, X is 5, the content reproducing unit will display, five seconds after displaying a given page, the next page. The user can turn no page, though he or she can stop preview reproduction by operating a stop button provided on the touch panel or the display device.

This function to allow preview reproduction enables the user to access an electronic book as if browsing a tangible book at a bookstore and to decide whether or not to buy the previewed book.

(5) Access and Reproduction Function

The user can perform on the user rack a book access operation on the purchased book.

The book reproduction flow after the content reproducing unit (105) has received from the input unit (101) a request for access and reproduction (step S3710) will be described with reference to FIG. 33.

The content reproducing unit (105) checks whether or not any previously accessed page of the access state information in the storage medium is registered (step S4201).

If there is any previously accessed page, reproduction will start at that page (step S4202).

If there is no previously accessed page, reproduction will start at page 1 (step S4203).

Though not shown, the input unit (101) accepts the user's operation regarding reproduction, such as turning the page; the content reproducing unit (105) instructs that operation; and the content reproducing unit (105) displays the page in accordance with that instruction. Upon the end of reproduction, the access state information is updated again.

Although the mode of implementing the invention described above concerned accessing an electronic book, the same advantage can be achieved if the book is replaced by some other content such as music, a film or moving picture content.

The difference is in the type of contents arranged on the shop rack and the user rack. If the contents are music, CD jackets will be displayed instead of book covers, or if they are films, DVD jackets will be displayed.

In the content reproducing unit having the block configuration shown in FIG. 1, the operation differs with the type of content to be reproduced. If it is a book, the processing will be to display the content on the display screen of the display device by way of a preview or access to the text; if it is music, the sound will be reproduced by an audio section of the display device for audition or serious listening; or if it is an animation, the video component will be shown on the display screen of the display device by way of a preview or viewing of the full edition and the audio component, reproduced by the audio section.

(Second Embodiment)

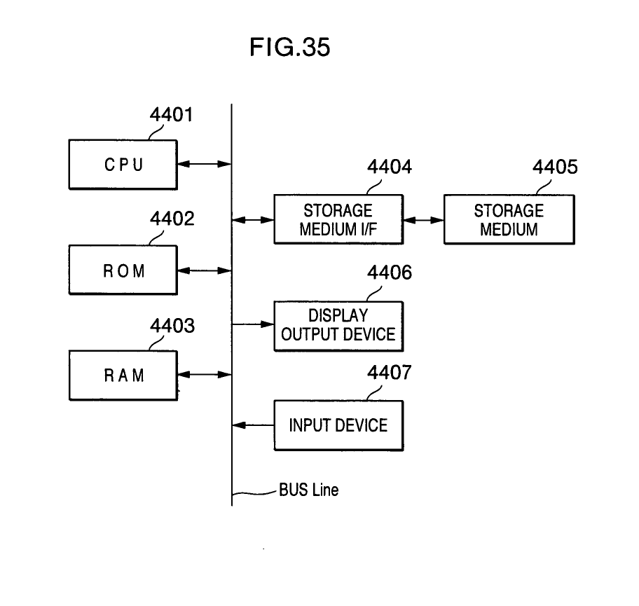

A display device for accessing electronic books will be described below as a mode of implementing the invention of display devices set forth in claims 15 through 45. FIG. 35 is a block diagram showing the configuration of the display device for accessing electronic books, which is a second preferred embodiment of the invention.

The display device is provided with a read only memory (ROM) 4402 in which an application program for accessing, purchasing or returning a book is stored, a central processing unit (CPU) 4401 for executing the application program, a random access memory (RAM) 4403 required for developing data of an execution file or a book at the time of execution, a storage medium interface (I/F) 4404 for interfacing a storage medium 4405 in which data including electronic book information is stored with the display device, an output device 4406 which is an interface with the display unit, and an input device 4407 for accepting user-operated inputs. These elements are connected to one another by a bus line.

Though not shown, to the tip of the input device 4407 are connected such input devices as buttons and the like provided on the touch panel and the display device.

Though not shown either, to the tip of the output device 4406 is connected, for instance, a thin and power-efficient type display device usable on a mobile terminal, such as a liquid crystal display unit.

The storage medium 4405 is supposed to be a semiconductor memory, such as a secure digital (SD) memory card, or an optical disk, such as a compact disk (CD) or a digital video disk (DVD).

In the display device, a user operation is accepted from the input device 4407, the CPU 4401 executes a corresponding program in the RAM 4403, developed out of the ROM 4402, and the content to be displayed is supplied to the display device through the output device 4406.

The operation of each function of this display device will be described below.

(1) Bookshelf Display Function

The display device has a built-in power supply unit driven by a replaceable or dedicated battery. When the power supply unit is turned ON, the CPU 4401 actuates a bookshelf display program in the RAM 4403, acquires bookshelf information in the storage medium 4405 via the storage medium I/F 4404, and supplies it for displaying on the display output device 4406.

The items contained in bookshelf information are shown in FIG. 2.

What is meant by bookshelf information is necessary information for displaying a bookshelf, and comprises a bookshelf ID (201) for identifying a given bookshelf, a bookshelf name (202) for indicating the category of the bookshelf, information (203) indicating the arrangement of the bookshelf, and a list (204) of books placed on the bookshelf.

On bookshelves, books are grouped by category, such as the genre or the price range. For instance, there is a new issue shelf, on which only new issues including newspapers are arranged, and a literature/review shelf, on which novels and other literary works are arranged.

Depending on the number of books belonging to a category, a bookshelf may have sub-shelves. For instance, the new issue shelf may further have within itself a newspaper sub-shelf, a weekly sub-shelf and so forth.

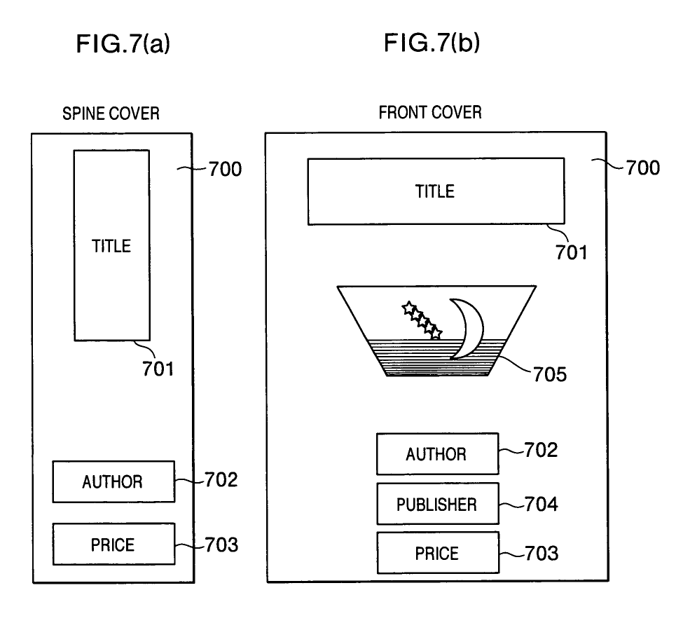

FIG. 7 illustrate examples of book cover.

In the smallest unit of bookshelf displaying, the spine (FIG. 7a)) and front (FIG. 7b)) covers of a book are shown on a bookshelf side by side.

On each book cover (700), the book title (701), the author's name (702), the book's price (703), the book's publisher (704), an image or a typical picture (705) of the book are displayed among other items.

The bookshelf comprises a shop rack on which purchased books are to be arranged and a user rack on which unpurchased books are to be arranged. Whether a given bookshelf is a shop rack or a user rack can be determined from the information (203) indicating bookshelf arrangement among various items of bookshelf information.

For instance, the information (203) indicating the arrangement of the bookshelf is in a directory structure to show whether a given bookshelf is part of the shop rack or part of the user rack; a bookshelf beginning with “/shop” belongs to the shop rack and a bookshelf beginning with “/user” belongs to the user rack.

FIG. 8 illustrate examples of bookshelf displaying.

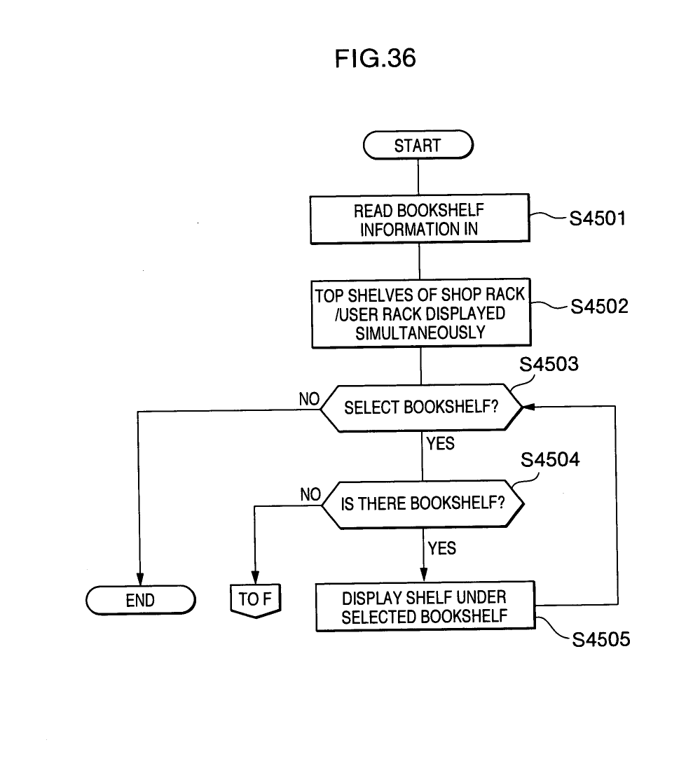

On the right half of the screen is displayed a shop rack (802) and on the left half, a user rack (801) (FIG. 8a) display example 1). FIG. 36 shows a flowchart of bookshelf displaying.

When the display device is actuated, as stated above, the CPU 4401 reads the bookshelf display program in the ROM 4402 and the bookshelf information in the storage medium into the RAM 4403 (step S4501), executes the program, and instructs the display output device 4406 to display the bookshelf (step S4502).

The user can instruct execution of such operations as moving the bookshelf and selecting a book through the input device 4407 such as a touch panel or a cross key button provided on the box of the display device. If the selection of a bookshelf is detected (step S4503), the existence of the selected bookshelf will be checked (step S4504).

If there are a plurality of bookshelves only the bookshelf names are displayed (FIG. 8b) display example 2-1), and if there is a sub-bookshelf within a bookshelf, selecting the bookshelf on the touch panel or the like will result in displaying of a list of sub-shelves under that bookshelf (step S4505).

For instance, if the “new issue shelf” (804) in the shop rack shown in FIG. 8b) is selected, a sub-shelf (804′) therein will be displayed on the screen (FIG. 8c) display example 2-2).

Further, if the “literature/review” shelf (807) is selected on the screen of FIG. 8b), book covers arrayed on that bookshelf will be displayed (FIG. 8d) display example 2-3).

Books (806) on the shop rack (809) are unpurchased ones, and the user can access none of the books on the shop rack (809) before purchase.

The user can preview or purchase a book from the shop rack screen (802) by a user operation.

Purchased books (805) are arrayed on the user rack (808), and the user can access any of them at any time.

The user can access or return a book from the user rack screen (801) by a user operation.

Details of the bookshelf functions will be individually described elsewhere in this specification.

Thus, bookshelves are equipped with necessary functions for using electronic books, whose basic use is accomplished by operations from the bookshelf screen.

By simultaneously displaying the shop rack screen (802) and the user rack screen (801) at the same time, the user is enabled to either purchase or access a book without having to switch over the screen.

(2) Periodicals Presenting Function

A user subscribing to a periodical such as a newspaper or a magazine is likely to access particularly frequently to the periodical relative to other books on the user rack.

Moreover, since freshness is an essential requirement for a newspaper, every issue should be made immediately accessible on the day of its publication.

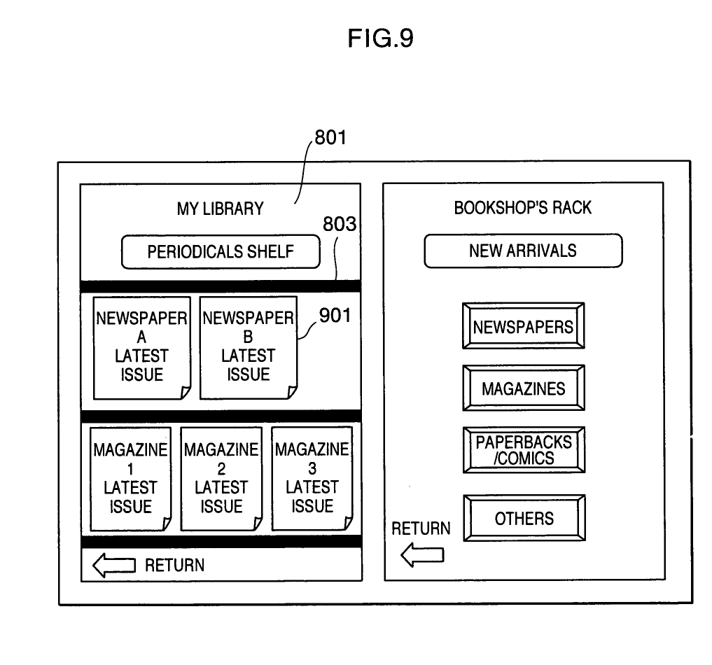

In view of this factor, only the respective latest issues of periodicals are displayed on their dedicated bookshelf (803) (FIG. 9).

When presenting a bookshelf in starting up, bibliographical information is referenced at the time of reading in bookshelf information (step S4501) to determine from the attribute (407) of bibliographical information whether or not the pertinent book is a periodical and, if it is a periodical, the book will be registered on the periodicals shelf (803), i.e. the bookshelf information will be rewritten and displayed.

FIG. 4 shows bibliographical information.

Bibliographical information includes the book ID (301), book's title (402), author's name (403), publisher (404), price (405) and issue date (406) for identifying the book, together with such items of information for identifying the bookshelf as an attribute (407), book cover (408), synopsis (409) and incidental information (410).

Details of the incidental information (410) will be described afterwards.

Whether or not a given periodical is the latest issue can be determined from its issue date (406), and if there is more than one book of the same book ID, the latest issue will be identified by its issue date (406).

The presence of this periodicals shelf (803) and automatic updating of books on the periodicals shelf enable the user to access the latest issues on the periodicals shelf (803) at any time.

(3) New Arrivals Presenting Function

Not only publishers want to promote their new books but also users want new publications to be presented in an easy-to-perceive way.

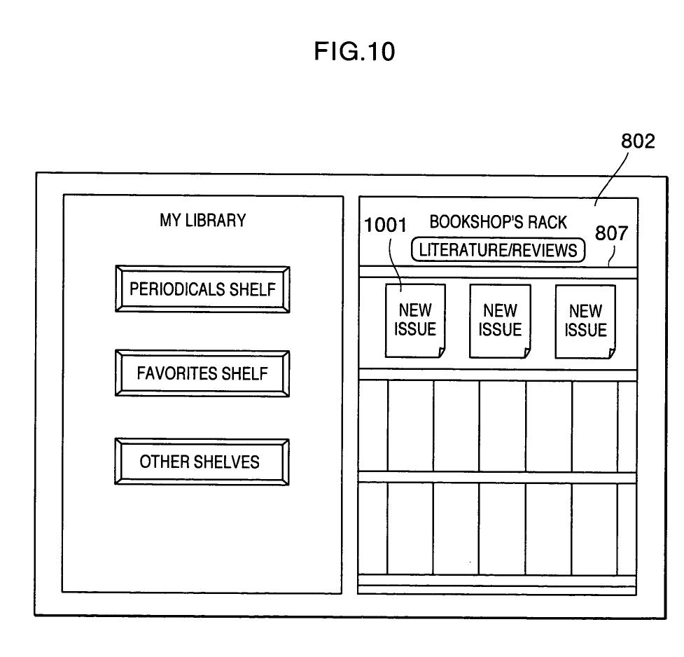

In view of these requirements, new arrivals are displayed in flat stacking (FIG. 7b)), a form of displaying in which the front cover is shown, on a bookshelf determined in accordance with the attribute of bibliographical information (1001 in FIG. 10).

A display control unit (102), in presenting a bookshelf, determines whether or not a given book is a new arrival from its issue date and, if it is, will present the book on a new arrivals shelf.

Whether or not a given book is a new arrival is determined according to, for instance, whether or not its issue date is within a certain period from the current day/hours.

That period is fixed in advance.

This enables the user to know at a glance new arrivals on a given bookshelf by having front covers of books, grouped by category, displayed on the bookshelf.

Apart from the user's desire, the publishers also desire to make their new issues known more effectively to the user.

To meet these desires, new arrivals can be displayed more conspicuously not only by stacking them flat but also by turning on and off intermittently the display of their covers.

The CPU 4401 reads a new arrivals information display program in the ROM 4402 into the RAM 4403 and executes it, and the new arrivals information display program performs processing to turn on and off the display of new arrivals intermittently, and supplies the new arrivals to the display output device 4406.

This enables the user to find new arrivals more effectively out of available books.

(4) Dual Screen-Interlocked Display Function

Choice of a book on a bookshelf on one side of the screen causes another screen interlocked to it to be displayed on the other side.

A display on the display device may either be formed of two separately controllable screens, divided either laterally or vertically around its main axis, or of a single screen divided into right and left controllable parts.

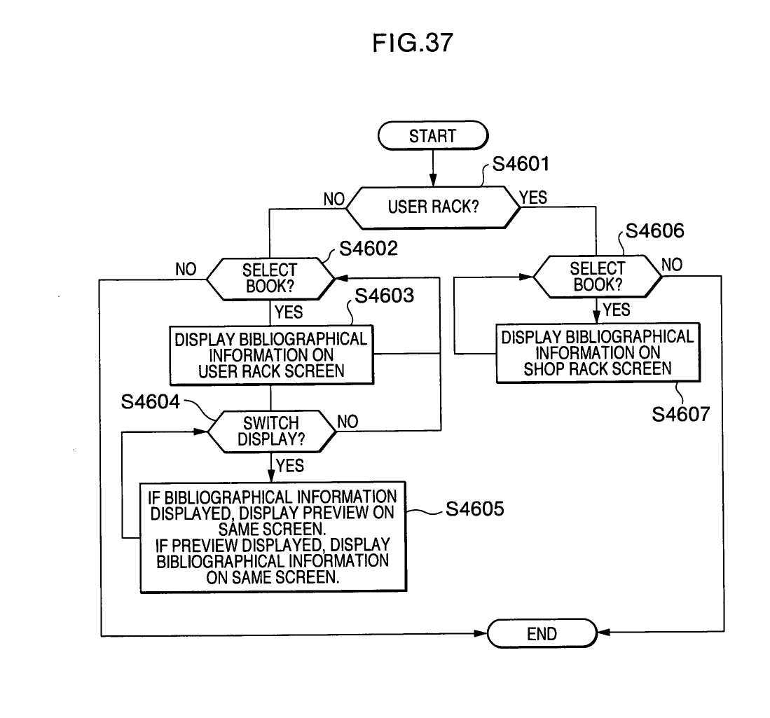

FIG. 37 is a flowchart at the time of displaying bibliographical information, which is summarized information.

In a state in which the shop rack screen and the user rack screen are displayed, if the book displayed on each shelf is entered from the input device 4407 by, for instance, selecting it on the touch panel, the CPU 4401 will read a bibliographical information display program in the ROM 4402 and bibliographical information in the storage medium 4405 into the RAM 4403 and execute the program.

First the CPU 4410 determines which of the user rack screen and the shop rack screen was operated to generate the data entered by the input device 4407 (step S4601).

Then it determines whether or not the data concern selection of a book (step S4602 and step S4606) and, if they do, will display bibliographical information on the book selected on the screen which is not the bookshelf screen to which the selected book belongs (step S4603 and step S4607).

Therefore the user, every time he or she selects a book, displays again bibliographical information corresponding to it on the other screen.

Bibliographical information, like the book text, is stored in the storage medium, and bibliographical information on all the books on the bookshelf is in the storage medium.

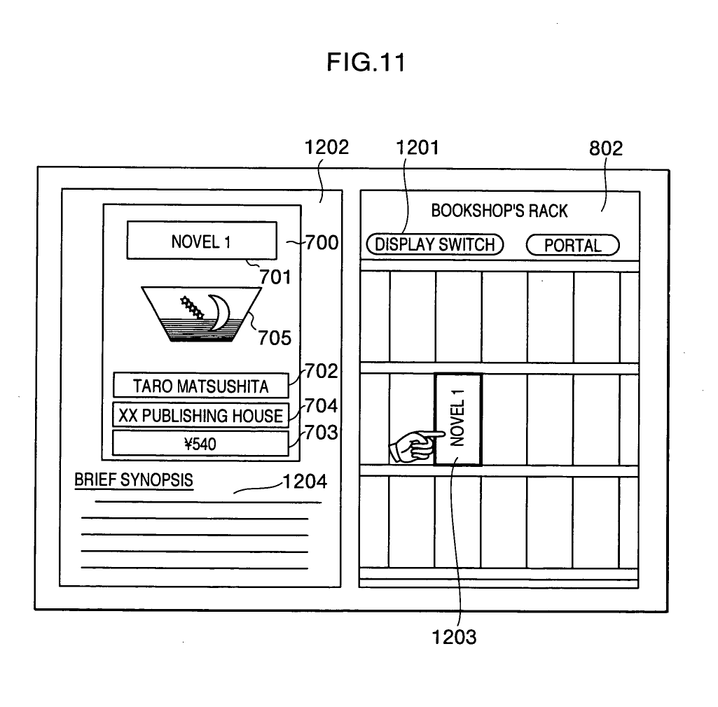

Displayed images will be described below with reference to FIG. 11.

For instance, when a book is selected on a touch panel or with a cross key on the shop rack screen displayed on the right side of the screen shown in FIG. 8a), bibliographical information on the selected book will be displayed on the left side screen (1202).

For instance as shown in FIG. 11, cover images showing the title and so forth (700 through 705) and a synopsis outlining the contents (409 and 1204) are displayed at the same time.

The bibliographical information that is displayed varies in an interlocked manner every time the user selects a book (1203). This enables the user to reference bibliographical information without the trouble of switching the display between a bookshelf and bibliographical information or without having to compress the display area of the bookshelf.

(5) Preview Function

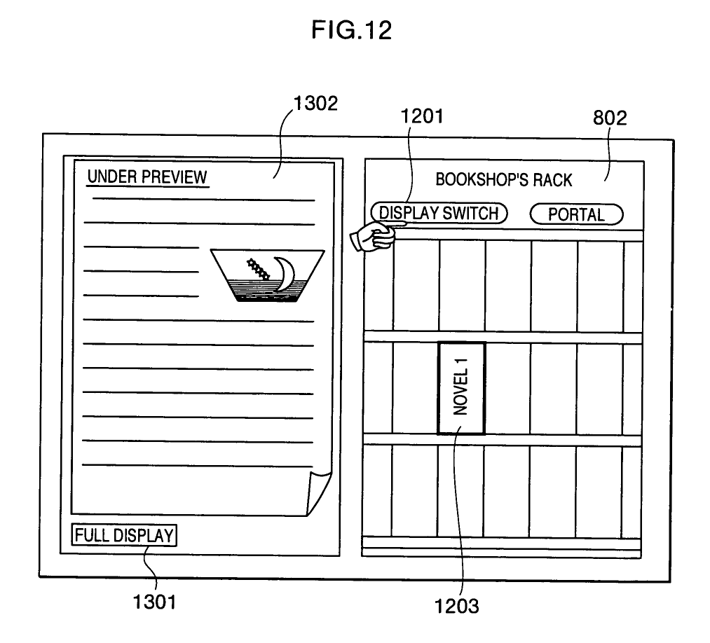

Further, the shop rack screen is provided with a button to switch between the bibliographical information display and the preview display. If, for instance, the user selects a display switch button (1201) while referencing bibliographical information as shown in FIG. 11, a preview screen will be displayed where bibliographical information has been displayed (1302 in FIG. 12).

FIG. 37 is a flowchart at the time of displaying a preview. As described above, the user selects a book on the shop rack screen and, in a state of displaying bibliographical information, if he or she enters from the input device 4407 switch button selection data from, for example, the touch panel, the CPU 4401 will read a preview reproduction program from the ROM 4402 into the RAM 4403 and executes it.

First, the CPU 4401 determines whether or not the data entered by means of the input device 4407 are display switching data (step S4604) and, if they are, will read the text of book information from the storage medium 4405 into the RAM 4403, and instruct the display output device 4406 to display a preview on the screen on which bibliographical information is currently displayed (step S4605). After that, the operation resulting from the inputting of display switch data varies with the contents of display; if display switching is selected during a preview display, bibliographical information will be displayed, or if display switching is selected during a bibliographical information display, a preview will be displayed.

Preview displaying is done by use of the book text of book information shown in FIG. 3.

Book information is information for managing the book text, and includes the book ID (301) for identifying the book, the return condition (302) as the criterion of determining whether or not the book can be returned, and the book text (303).

For a preview here, the duration of access per page is determined and, when that duration is over, the CPU 4401 supplies the next page data to the display output device.

The user cannot do such an operation as rewinding or stopping during a preview. This preview display enables the user to know the volume and structure of the book contents, and he or she can decide to buy or not to buy a given book on the basis of dual sources of information including the bibliographical information and the preview.

By selecting the display switch button (1301) at the bottom left of the preview screen shown in FIG. 12, it is possible to switch the preview display from the half size to the full size.

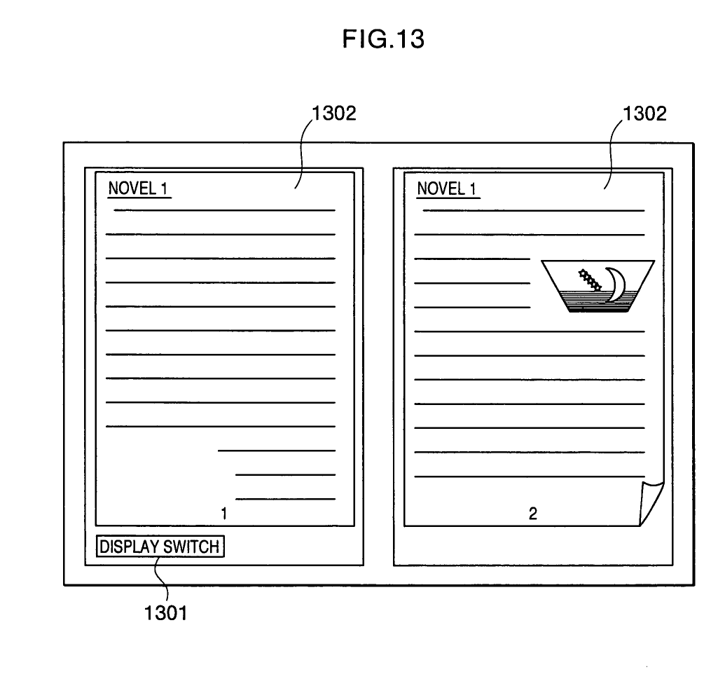

The screen after the switching is shown in FIG. 13.

By selecting the display switch button (1301) at the bottom left of FIG. 13, the display can be returned to the half size.

(6) Bookshelf Automatic Presenting Function

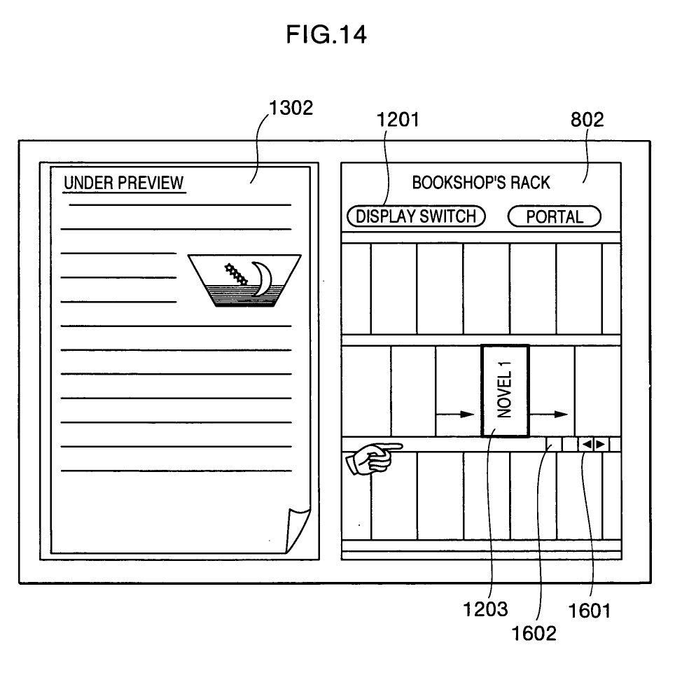

When the user selects a bookshelf, books are displayed in a manner as if they were automatically slid in a rotation (FIG. 14).

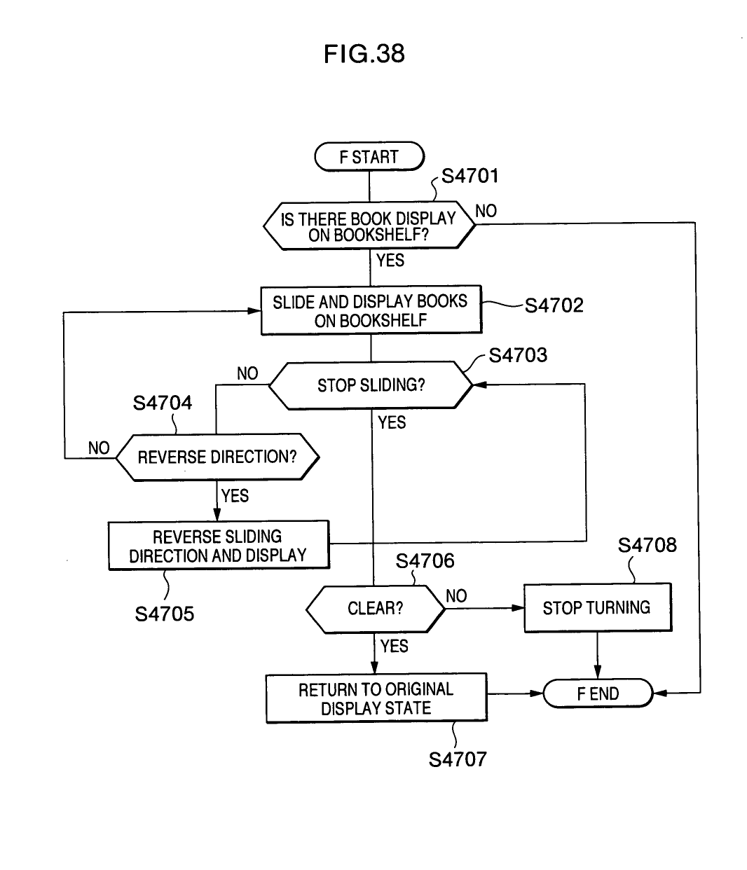

FIG. 38 is a flowchart at the time of automatic bookshelf presentation.

This is a continuation of the flow following the absence of any sub-shelf under the bookshelf selected by the determination at step S4504 of FIG. 36.

First, when the user selects a bookshelf, it is determined whether or not any book is displayed on that selected bookshelf (step S4701).

If it is determined that any book is displayed, the CPU 4401 will read out of the RAM 4403 a bookshelf automatic presenting program for displaying a bookshelf while moving book covers on it in one direction at a constant speed, and supplies the program to the display output device 4406.

The title and the author's name displayed on the book cover are also slid at a speed not too fast to make them recognizable.

During that while, a specific book cover is focused on for a certain period, and after that the next book cover will be focused on.

While the cover of a book is in focus, bibliographical information on the book is displayed on the other part of the screen. If, while a sub-shelf under a bookshelf is being displayed in rotation, anything else than a bookshelf is displayed, the rotation will stop.

During rotation, an operation button (1601), which permits reversing of the rotation, and a stop button (1602) are displayed and these buttons or a button provided on the hardware is used for operating the display. If the user selects the “motion button” (step S4704), the rotation of the display will be reversed in direction (step S4705).

If the user selects the “stop button” (step S4703), the bookshelf will be displayed in anon-rotating state (step S4708) and, if the “stop button” is selected again to restore the display (step S4706), the restored state will be displayed (step S4707).

This enables the user to automatically know books on the bookshelf without having to move the displayed position of the bookshelf.

(7) Book Purchasing Function

Purchase of a book can be accomplished by a user operation from the shop rack screen.

A description of the flow is dispensed with because it is similar to what was described with reference to FIG. 29 in connection with the first embodiment of the invention. If then a device for sensing any user operation on the touch panel or elsewhere in the screen senses the choice of a book on the shop rack screen and a drag of the book on the touch panel displayed to the user rack screen or the selection of a purchase button on the shop rack screen, the CPU 4401 will read a purchase program out of the ROM 4402 into the RAM 4403 and process its execution.

At step 3802, a purchase confirmation screen is displayed to confirm the purchase and, after confirming the user's intent, the process goes ahead to step S3803.

After that at step S3803, the cover of the book is displayed on the user rack screen through the display output device 4406. The purchase history recorded at step S3808 is registered here into the storage medium.

Displaying the book cover on the user rack screen enables the user to know that the book has become accessible, and the user can start accessing the purchased book immediately after operating for the purchase of the book not yet purchased until then.

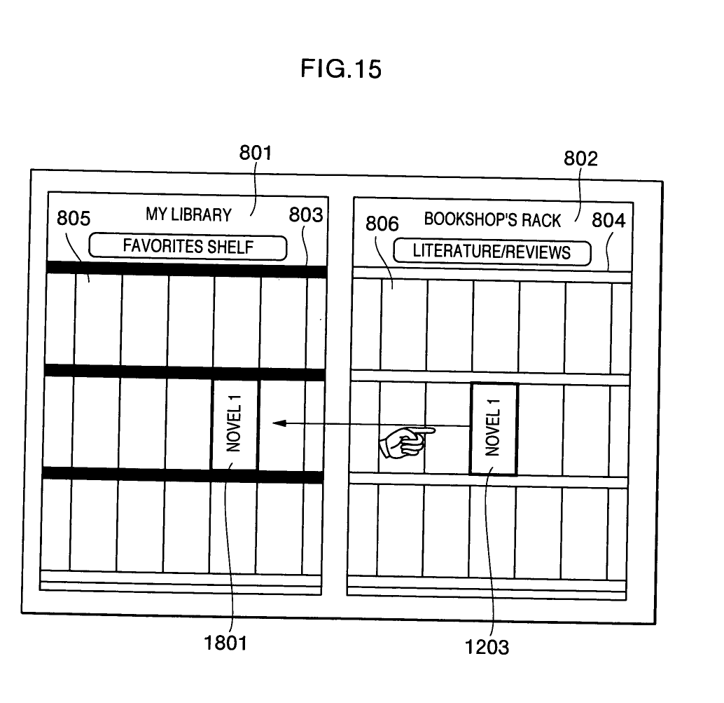

FIG. 15 illustrates an example of imaged purchase operation.

Selection is done by touching with a finger the desired one of the shops on a bookshelf in the shop rack part displayed on the right side. When the selected book is dragged to the user rack screen on the left side, the purchase confirmation screen is displayed.

For instance, a window with a question of “Do you buy?” is displayed, and the user can reply by pressing a button of “Yes” or one of “No”.

If “Yes” is selected, the cover of the book selected will be displayed on the user bookshelf (1801).

The items of bookshelf information altered at S3803 are shown in FIG. 16.

If a book whose book ID is 1x0111 has been purchased, 1x0111 will be added to the book ID list in the bookshelf information of the favorites shelf on the user rack.

The data structure of the purchase history recorded at step S3802 is shown in FIG. 5.

The purchase history includes the book ID (301) for identifying the book, classification information (502) indicating whether the action is a purchase or a return, and the date (503) on which the history items are recorded.

This purchase history is delivered to the account settlement processing server when communication with the account settlement processing server responsible for account settlement becomes possible.

A detailed description of the means of communication and other aspects of the account settlement processing server will be dispensed with here because they are irrelevant to the essentials of the invention as is the case with the first embodiment thereof.

In the processing for a book purchase, it is possible to require inputting of the user's password when he or she makes a purchase operation in order to prevent anybody else than the owner of the pertinent user rack from making a purchase not authorized by the owner.

If it is to be required, at step S3802 in the book purchasing operation described above, before displaying the purchase confirmation screen, a password input screen will be displayed to urge the user to enter the password.

The CPU 4401, upon receiving from the input device 4407 password information entered by use of a cross key or a soft key, compares the received password information with password information stored in the storage medium and, if they are found identical, will execute the exact sequence from step S3802 to S3804 shown in FIG. 29.

If they are not found identical, the password input screen will be displayed again.

On the password input screen, a cancellation button to cancel the purchase itself can also be selected.

This arrangement can prevent a third party from making a purchase without the consent of the owner.

(8) Order Placement Function

The limited size of the storage medium may prevent book information positioned on the shop bookshelf (FIG. 3) from being present in the storage medium.

In that case, too, the covers of books are displayed on the shop rack, and bibliographical information can be accessed, but it impossible to access the text during a preview or immediately after the purchase. The operation that takes place when the user makes a purchasing action in the absence of the book itself in the storage medium will be described below.

A description of the flow is dispensed with because it is similar to the flow shown in FIG. 29 described in connection with the first embodiment of the invention.

Then, as a device for sensing user operations on the screen, such as a touch panel, detects the selection of a book on the shop rack screen and the dragging of the book to the user rack screen on the touch panel screen or the selection of the purchase button on the shop rack screen, the CPU 4401 reads the purchase program from the ROM 4402 into the RAM 4403, and executes it.

At step S3805, each purchase order is displayed on the screen and, after the user's intent is confirmed, the process moves ahead to step S3804.

After that at step 3804, the cover of the book which the user has ordered will be displayed on the ordered book shelf on the user rack screen through the display output device 4406.

When a purchase order is placed for the first time, if there is no ordered book shelf on the user rack screen, an ordered book shelf will be newly generated.

When any of the books arranged the ordered book shelf has arrived, the arrival is indicated by changing the color of the ordered book shelf.

Arrival means the presence of the substance of the book in the storage medium.

The substance of any book on the ordered book shelf, if in a state of communication with a storage server in which books are stored, will be automatically updated.

Regarding books arranged on the ordered book shelf, when power supply is turned ON, the storage medium is referenced at step 4501 in the flow of bookshelf information display shown in FIG. 36 and, with reference to the book ID list in which the bookshelf name of bookshelf information (FIG. 2) is “ordered book shelf”, it is checked whether or not the pertinent book is found in book information (FIG. 3).

If the result of the checkup reveals the presence of the book on the ordered book shelf in the storage medium, the color of the displayed ordered book shelf will be changed.

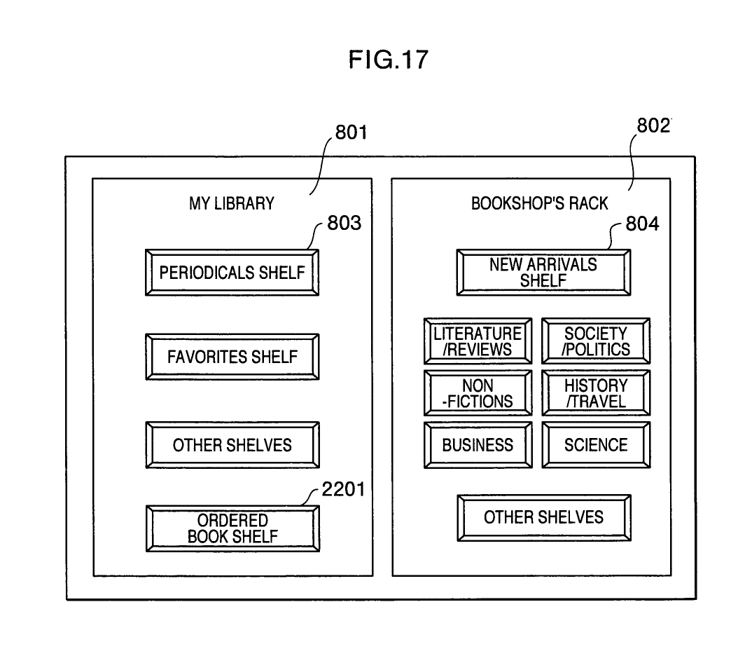

FIG. 17 illustrates an example of shelf display screen when one of the books on the ordered book shelf has arrived. The ordered book shelf 2201, which is in the same color as other bookshelves on the user rack, is changed in color when the book has arrived.

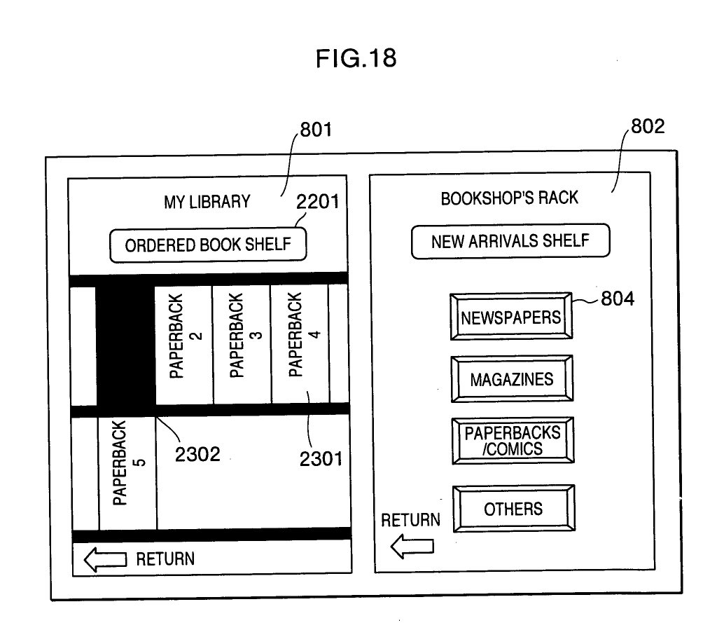

Further, to distinguish the cover of the book that has arrived from those that have not among the books on the ordered book shelf, for instance, the cover of the former is colored in a usual way (2302 in FIG. 18) while those of the latter is displayed in a translucent color (2301 in FIG. 18).

The user is thereby enabled to know at a glance whether or not the ordered book has arrived.

The user senses from the device for sensing user operations on the screen such as a touch panel the selection of the book on the ordered book shelf.

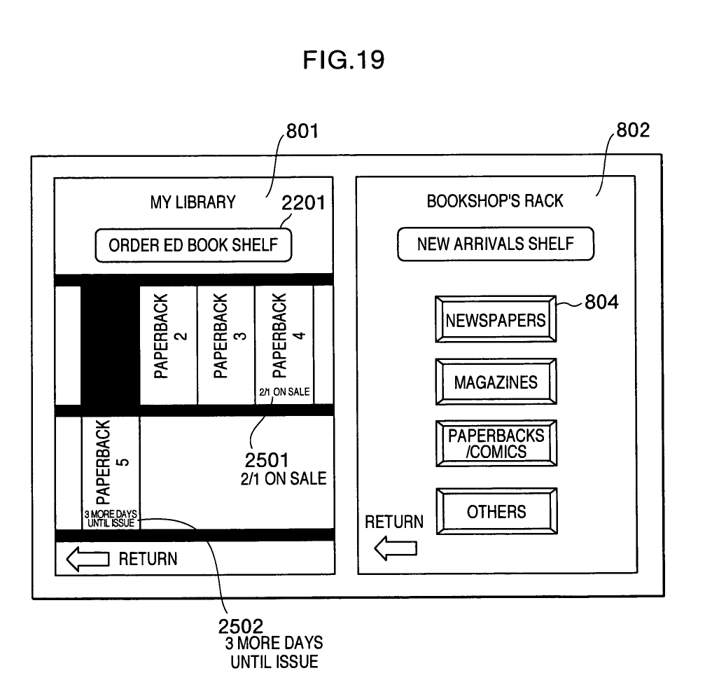

If there is any unreleased book on the ordered book shelf, the scheduled issue date (2501 in FIG. 19) or the number of days before its issue (2502 in FIG. 19) will be displayed on its cover.

The scheduled issue date is stated in the issue date information box in the bibliographical information (FIG. 4).

When the number of days before issue is to be displayed, the number of days from the current day until the scheduled issue date is computed at the time of displaying the book cover and the computed result is displayed.

This enables the user to know when the ordered book will become available.

When the book is displayed on the user rack after its purchase, it is now accessible.

However, it is not known whether or not the account is settled immediately after the purchase.

Account settlement means that the purchase history in the storage medium is transmitted to the account settlement processing server. Once communication is established to the account settlement processing server, the purchase history is transmitted to the account settlement processing server.

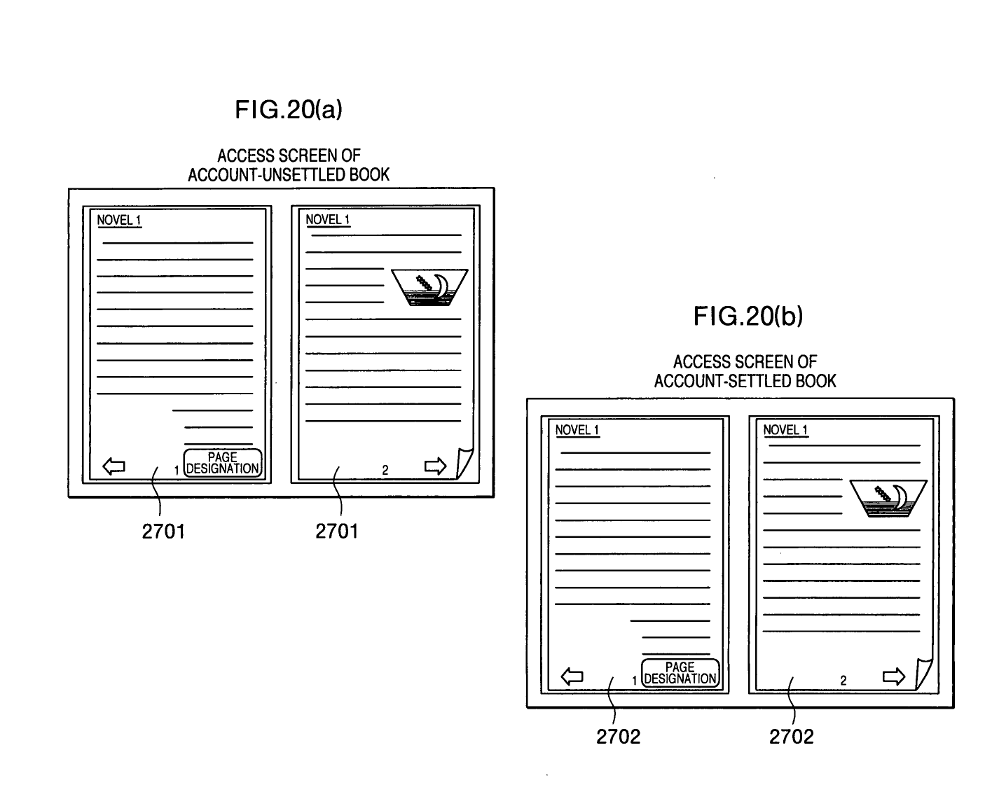

In accessing the purchased book whose account has not yet been settled, the background of the book is displayed in a different color to indicate the unsettled account (FIG. 20).

Whereas the accessing flow will be described elsewhere in this specification, the purchase history is checked when displaying the book for access, and it is determined whether or not to change the background of the book.

This enables the user to be aware of the unsettle account, and can be expected to urge him or her to settle it without delay.

(9) Return Function

An operation to return a purchased book can be done on the user rack screen.

A description of the flow is dispensed with because it is similar to the flow shown in FIG. 30 described in connection with the first embodiment of the invention.

Then, as a device for sensing any user operation on the touch panel or elsewhere in the screen senses the choice of a book on the user rack screen and a drag of the book on the touch panel displayed to the shop rack screen or the selection of a return button on the user rack screen, the CPU 4401 will read a return program out of the ROM 4402 into the RAM 4403 and execute it.

At step S3904 or step S3904, a return confirmation screen to confirm the return is displayed and, after confirming the user's intent, the process goes ahead to step S3906.

After that at step S3907, the output of book cover erasion for the returned book is carried out on the user rack screen through the display output device 4406. Or if the return condition is found unsatisfied at S3902 a screen stating the reason for return will be displayed.

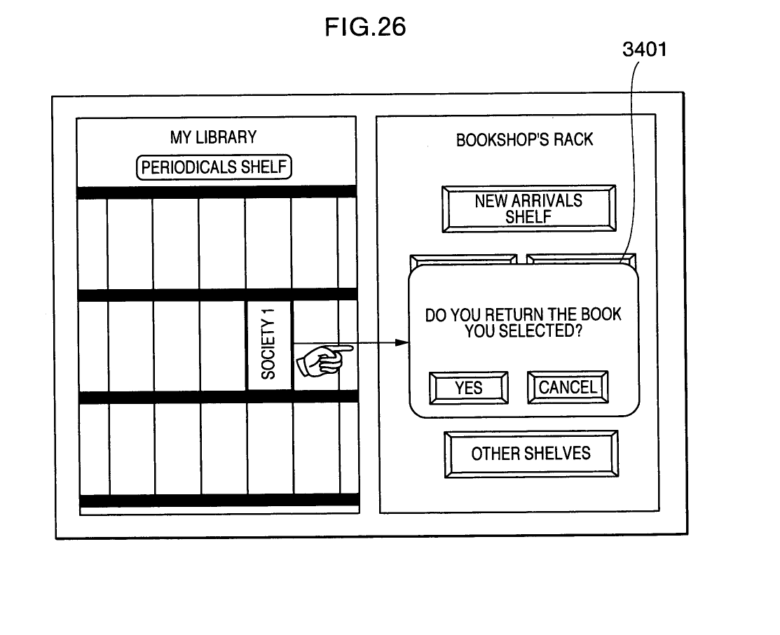

FIG. 26 illustrates an example of return confirmation display screen.

As the user selects the book on the user rack to be returned and drags it to the shop rack, a screen to confirm his or her intent to return it is displayed (3401), and if he selects “YES”, the cover of Harray Potter disappears from the displayed user rack to complete processing of the return.

This enables the user to easily process the return of the book even though it has been once bought.

After the completion of return processing, a message input screen is displayed to let the user's reason for the return be stated, and the user can state it by such means as a soft keyboard.

Further, when the display device is in a state of communication with a customer support center, that message can be transmitted to the customer support center by e-mail or some unique application.

A book bought at a conventional bookstore or the like has a tangible substance of printed paper, and it is impossible to determine how much of it has been accessed.

Therefore, for a conventional book, its return has not been accepted as a normal commercial practice unless there is some problem in the book itself or on the part of the vendor.

For an electronic book, however, it is possible to detect whether or not it has been accessed and, if it has been, how much of it has been accessed.

Therefore, by managing that information, it is made possible to accept a return for a reason on the user's part.

(10) Access and Reproduction Function

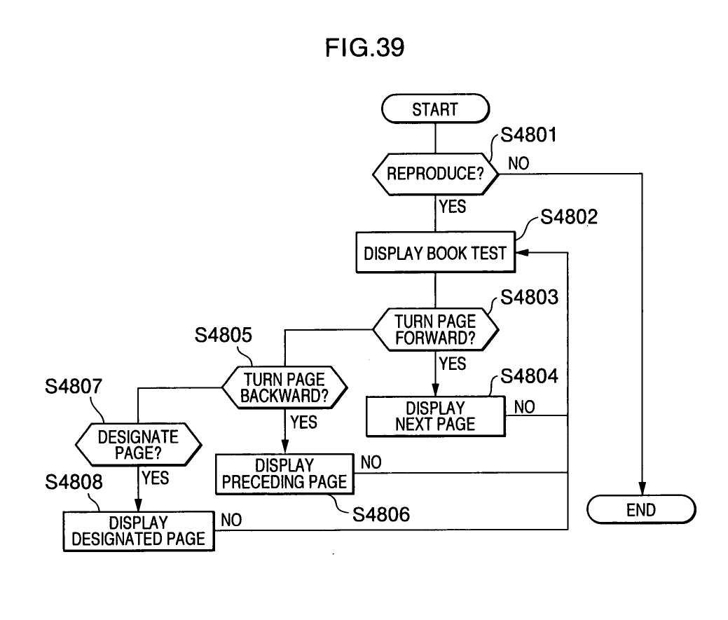

This function enables a book on a bookshelf displayed in the user rack screen to be accessed. FIG. 39 is a flowchart at the time of the access and reproduction display.

First, it is determined whether or not the user operation instructs reproduction of a book (step S4801).

If the user selects any book on the user rack and selects that book again or select a reproduction button provided on the screen or on the box, it will be determined that an instruction to reproduce the book has been given.

If it is found that the instruction is for reproduction, the CPU 4401 will read an access and reproduction program from the ROM 4402 and book text data from the storage medium into the RAM 4403, execute the program and supply the book text data to the display output device 4406.

Then, the previously accessed page of the accessed state information present in the storage medium (see the description of the first embodiment for more details) is referenced, and that page is displayed (step S4802).

Next, a user operation to turn the page is sensed, and an action display corresponding to that operation is provided (from step S4803 through step S4808).

For the page designation at step S4807, there is an inputting action by which the table of contents is displayed, out of which the user can select the corresponding page.

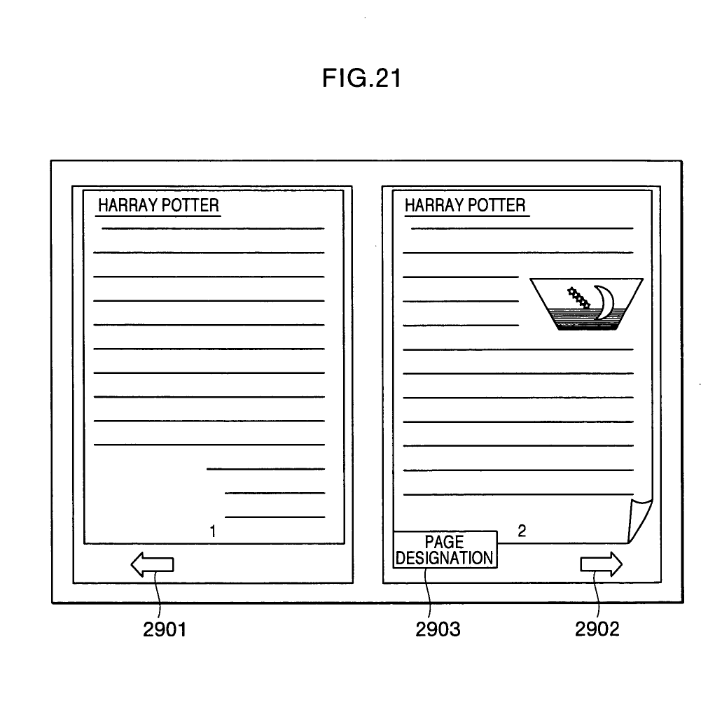

FIG. 21 illustrates an example of access display screen.

The access display screen is provided with such operation buttons necessary for accessing as ones for forward page turning (2902), backward page turning (2901) and page designation (2903), which the user can manipulate to change the accessed page.

The previously accessed page (605) of the access state information (FIG. 6) was recorded when the previous access was stopped.

The book on the bookshelf displayed on the user rack screen is accessible as long as it is in the storage medium, but it may have been shifted to another storage medium depending on the availability of a storage area in the storage medium in which it is usually stored.

Therefore, the display unit selects either the book cover on the user rack or the book cover, and displays on the bibliographical information displayed on the other part of the screen information indicating whether or not the book can be immediately accessed.

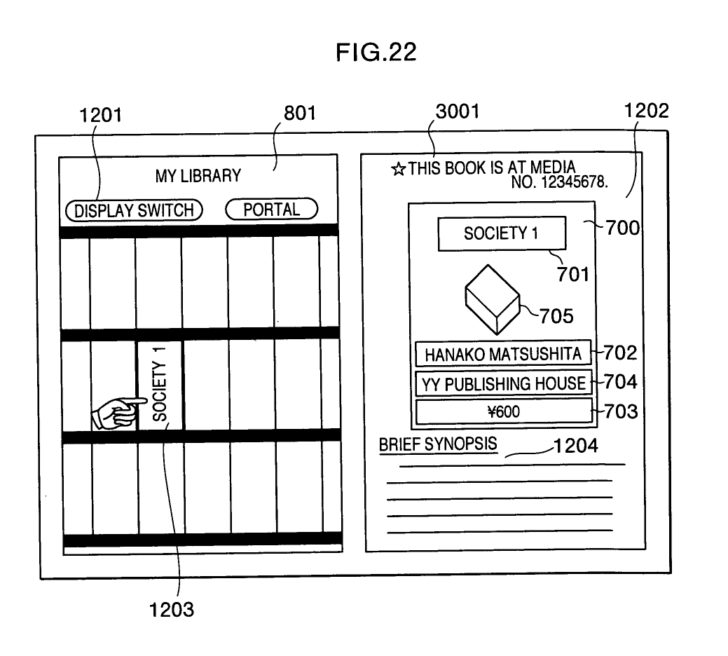

If it is not immediately accessible, information indicating the location of the book will be displayed (3001 in FIG. 22).

This enables the user to know at a glance whether or not the book is accessible.

The display unit determines the access state from the last accessed page (606) of the access state information managed by the access stage managing unit (104), and displays on the book cover the access state in an immediately perceivable way.

The access state may be “not yet read”, “being read” or “already read”.

When the last accessed page is 0, the book is determined to be “not yet read”.

Or when the last accessed page is between the final page and page 1, the book is determined to be “being read”.

Or when the last accessed page coincides with the final page of the book, the book is determined to have been “already read”.

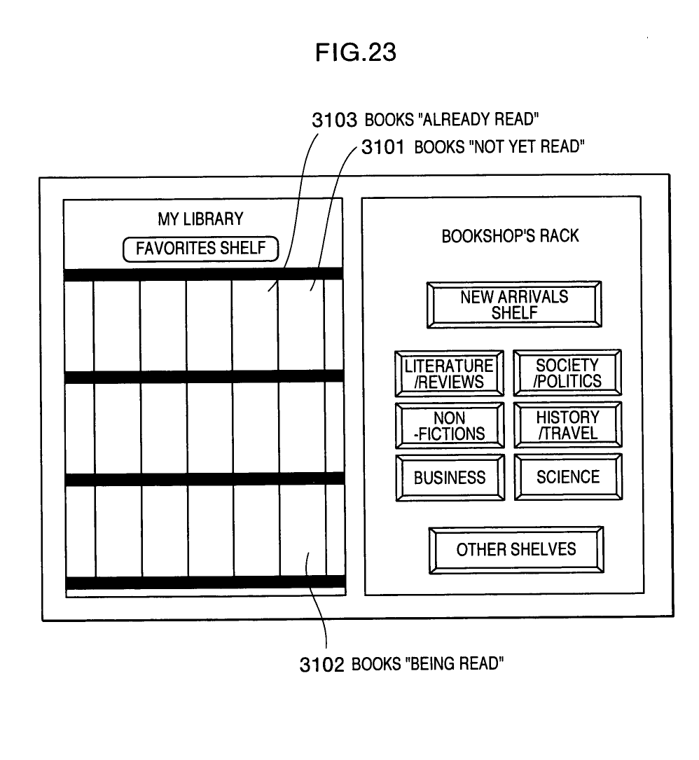

FIG. 23 illustrates an example of access state display screen.

For instance, where the access state is to be differentiated by the color of the book cover, the cover of a unread book can be colored in red (3101), that of a book being read in blue (3102), and that of a book already read in gray.

The access state expressed on the book cover may be differentiated by relative brightness instead of color.

This enables the user to perceive the access state of a book on the bookshelf at a glance, and facilitates his or her search for the book to be accessed.

(11) Function to Lock Access with Password

In accessing a book, it is possible to require inputting of the user's password when he or she makes an access operation in order to prevent anybody else than the owner of the pertinent user rack from making an access not authorized by the owner.

At step S4801, a screen for entering the password is displayed.

When password information entered by use of input means such as a cross key or a soft key is acquired, the received password information and password information stored in the storage medium are compared and, if they are found identical, S4801 through S4808 in FIG. 39 are executed.

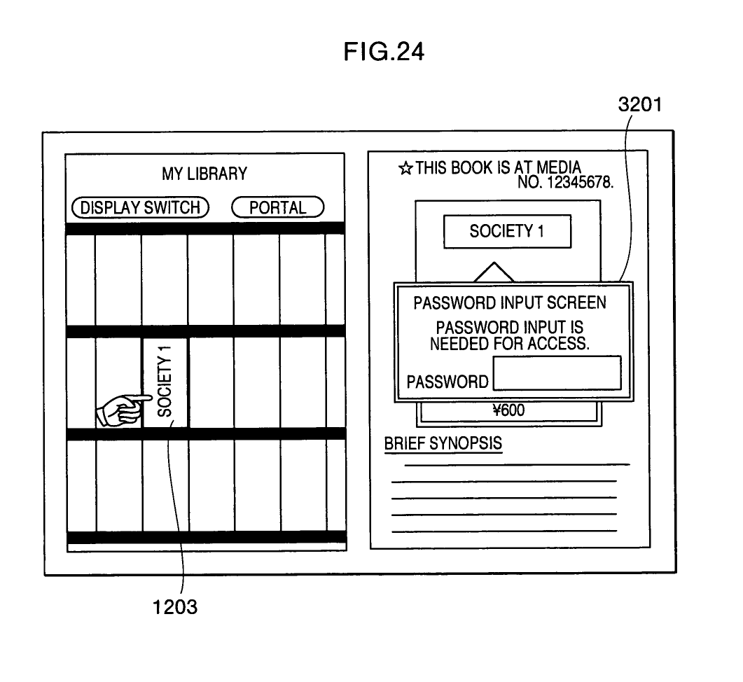

If they are not found identical, the password input screen will be displayed again. On the password input screen, a cancellation button to cancel the purchase outright can be selected as well. FIG. 24 illustrates an image of the password input screen. When the user performs an access operation, the password input screen is displayed to urge the user to enter the password.

It is up to the user to lock accessing with the password, and the password lock may either be confined to specific books or involve a whole bookshelf or the whole user rack.

This makes it possible to prevent any third party from making any access not authorized by the owner.

(12) CM Display Function

When a book on the user rack is selected, incidental information on that book is displayed on the screen on which bibliographical information is displayed.

Incidental information includes such an item of information to be made known to the user as, if for instance the book belongs to a series of which more books are oncoming, “next issue is already available” or, it not yet available, “to be issued on XX (month) YY (day)!”.

Incidental information (410) is managed as part of bibliographical information.

In performing display at step S4603 or step S4607 of the display flow of bibliographical information on a book, the bibliographical information (FIG. 4) is acquired from the storage medium and displayed and, if it is accompanied with incidental information, that incidental information will also be displayed at the same time.

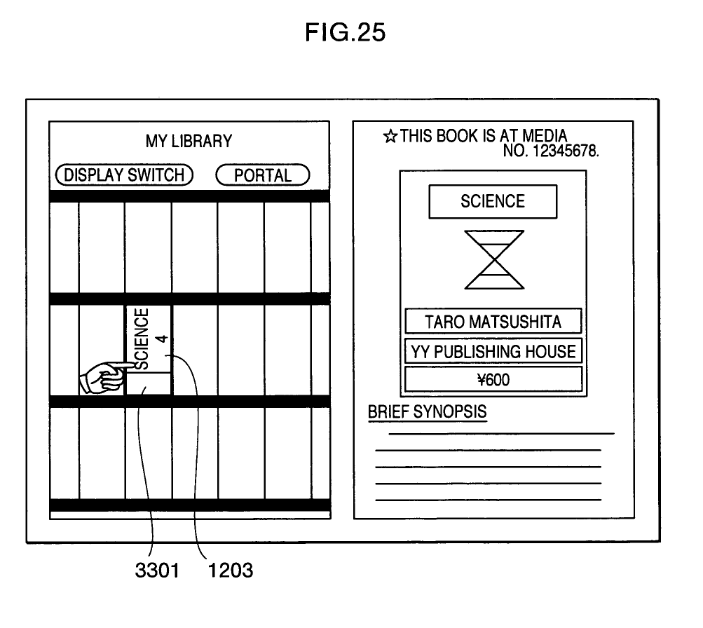

Incidental information may also be displayed like the cover belt of a book instead of presenting it on the bibliographical information screen (FIG. 25).

This enables the user to acquire further information related to the book he or she has bought even after the purchase. It also is an effective promotional tool for the shop.

Bibliographical information containing an advertisement of a magazine or a newspaper can undergo updating of the advertising information alone even for a book on the user rack.

As stated above, the books as such in the storage medium are automatically updated when it is in a state of communication with the storage server in which books are stored.

Then, while the books as such on the shop rack are usually updated, magazines containing any commercial message, among the books on the user rack may also be updated.

This enables the user to look at, when accessing a magazine or newspaper, the latest advertising information of the same periodical.

(13) Function Stop Function

As noted above, in purchasing a book, merely processing the purchase does not complete settlement of the account.

Therefore, after a book is purchased, the seller needs to have the account settled as soon as possible.

To meet this need, it is so arranged that the purchase history in the storage medium be referenced and, unless necessary transmission is done to the account settlement processing server within a certain period from the purchase date, the purchase, access and other functions of the display device cannot be used.

In the bookshelf information display flow shown in FIG. 36, when the power supply is turned ON, the storage medium is referenced at step S4501 to check the purchase date in the purchase history (FIG. 5) and, if the earliest date in the history has passed a certain period, a function stop program will be read out of the RAM 4403 and processed so that no input from the input device can be accepted thereafter.

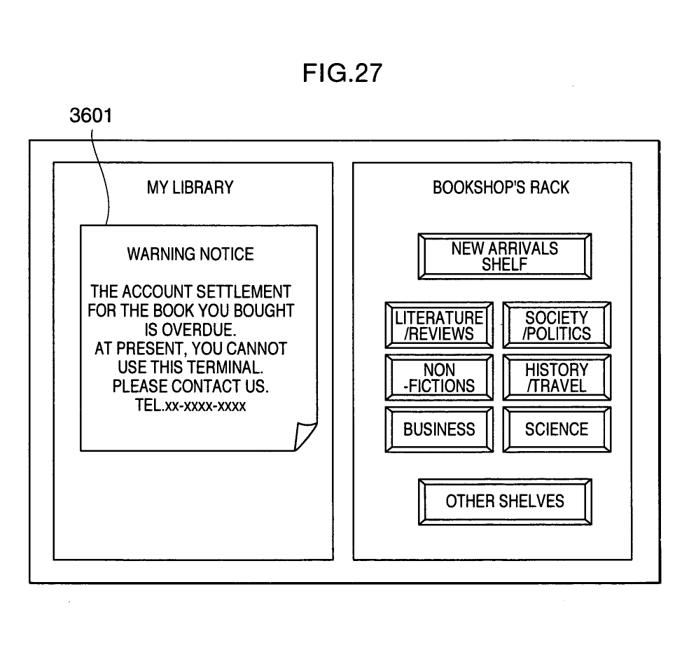

Then, a notice of function stop is displayed by the display output device. FIG. 27 illustrates the display screen that is shown when the functions are stopped.

On this screen are stated the notice of function stop, its reason and how the user can respond to it. This makes it possible, even in a system in which purchase processing and account settlement are separated from each other, to enhance the processing of account settlement in punctuality.

It is also possible, instead of stopping the functions immediately, to effect such control as to display a message urging account settlement beforehand or to make unavailable some of the functions, for instance accessing any book whose account is not yet settled.

This provides an effect to urge the user to settle his or her account like the aforementioned display at the time of accessing any book whose account is not yet settled.

While the advantages of enabling books to be bought and/or returned through a display device for accessing electronic books were noted with reference to the first embodiment of the invention, the description of the second preferred embodiment has presented effective utilization and display methods, which only electronic data can provide, in the mode of utilization relying on that display device.

(Third Embodiment)

A service providing system for accessing electronic books will be described below as a mode of implementing one or another of the service providing systems set forth in claims 46 through 80 of the present invention.

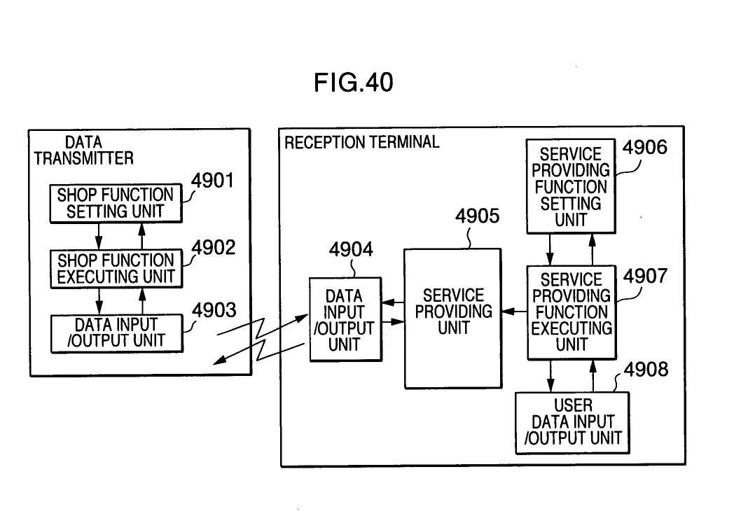

FIG. 40 is a block diagram showing the block configuration of a service providing system for accessing electronic books, which is a third preferred embodiment of the invention.

In a service providing system for transmitting and receiving data by use of wireless or wired transmission paths, a data transmitter is provided with a shop function setting unit (4901) capable of setting such functions as the method of displaying information and the kind of service to be provided; a shop function executing unit (4902) for executing and processing the function set by the shop function setting unit (4901); and a data input/output unit (4903) for transmitting and receiving the result of execution by the shop function executing unit (4902) and the result of output from a reception terminal to be described in further detail afterwards. The reception terminal has a data input/output unit (4904) for receiving data from the data transmitter, a service providing unit (4905) for executing a display or a function according to the received data; a service providing function setting unit (4906) capable of setting a function for providing a unique service at the reception terminal; a service providing function executing unit (4907) for executing and processing the function set by the service providing function setting unit (4906); and a user data input/output unit (4908) for accepting input data from the user when the function is to be executed by the service providing function executing unit (4907) and transmitting and receiving data to be used for executing the function. In the service providing unit (4905), service combining the function set in the shop function setting unit (4901) and the function set in the service providing function setting unit (4906) is provided.

First the reception terminal, when sensing the turning ON of power supply by the user, the service providing function executing unit (4907) demands from the service providing unit (4905) presentation of information on bookshelf for the shop, on which books usable at the reception terminal are arranged.

Responding to it, the service providing unit (4905) demands from the data transmitter via the data input/output unit (4904) acquisition of bookshelf information for shop use and bibliographical information.

The data input/output unit (4904), using a mechanism of communication to a mobile telephone network, a wired Internet network such as ADSL or a wireless Internet network using IEEE 802.11b or IEEE 802.11a, demands from the data transmitter acquisition of bookshelf information and bibliographical information.

The data transmitter accepts the demand from the data input/output unit (4903), and demands from the shop function executing unit (4902) acquisition of bookshelf information for shop use and bibliographical information for shop use.

The shop function executing unit (4902) acquires bookshelf information and bibliographical information from the shop function setting unit (4901), and transmits data to the reception terminal via the data input/output unit (4903).

The data input/output unit (4904) hands over to the service providing unit (4905) the data acquired from the data transmitter, and the service providing unit (4905) displays on a display unit provided at the reception terminal bookshelf information and bibliographical information both for shop use transmitted from the data transmitter as well as the shop rack and user rack from the bookshelf information for user use which the service providing unit (4905) holds for itself.

A description of the bookshelf information, bibliographical information, shop rack and user rack is dispensed with here because they are the same as what were described in detail with reference to the first embodiment.

The user can enter data from the touch panel or with a button provided on the box itself of the reception terminal.

The user operation is received by the user data input/output unit (4908), and handed over to the service providing function executing unit (4907).

At the reception terminal, for instance, purchasing of a book on the shop rack can be processed.

The user selects a book from the shop rack and operates for its purchase.

The purchasing operation is conveyed to the service providing function executing unit (4907) via the user data input/output unit (4908), and the service providing function executing unit (4907), in accordance with a purchasing process held by the service providing function setting unit (4906), demands from the service providing unit (4905) transmission of information on the purchased book and the displaying of the purchased book on the user rack.

The service providing unit (4905) delivers the information on the purchased book to the data transmitter through the data input/output unit (4904).

The data transmitter receives with the data input/output unit (4903) information on the purchased book and registers purchase information in the shop function setting unit through the shop function executing unit (4902).

Further, the shop function setting unit (4901) transmits data on the purchased book itself to the reception terminal through the data input/output unit and, at the reception terminal, the data is saved in the service providing unit (4905).

Purchase information is an identifier which uniquely identifies a given book. The data transmitter manages purchase information on a user-by-user basis, and subsequently settles the account with each user according to this information.

When a book on the user rack is desired to be accessed, the user selects the book on the user rack from the touch panel or with a button provided on the reception terminal, and performs an accessing operation.

The user data input/output unit, responding to that operation, places an access demand with the service providing function executing unit (4907).

The service providing function executing unit (4907), in accordance with the accessing process held by the service providing function setting unit (4906), places an access demand for the selected book with the service providing unit (4905).

The service providing unit (4905) displays on the display unit the book on the user rack it holds internally.

At the reception terminal, not only can a book on the shop rack be purchased but also can a book on the user rack be returned. When it is desired to return a book on the user rack, the user selects the book on the user rack from the touch panel or with a button provided on the reception terminal, and performs a return action.

The user data input/output unit, responding to that operation, places a return demand with the service providing function executing unit (4907).

The service providing function executing unit (4907), in accordance with the returning process held by the service providing function setting unit (4906), demands from the service providing unit (4905) determination as to the returnability of the book and, if returnable, transmission of information to the data transmitter.

The service providing unit (4905) references access state information on books on the user rack it holds internally, and determines whether or not the book can be returned.

A description of the access state information and the returnability determination is dispensed with here because they are the same as what were described with reference to the first embodiment.

The service providing unit (4905), if it determines that the book is returnable, will transmit to the data transmitter information on the book to be returned, and delete from the book information and bookshelf information it holds internally the returned book.

At the data transmitter, the data input/output unit accepts the information on the book to be returned, and the shop function executing unit hands over return information to the shop function setting unit.

As described above, this data providing system makes it possible for electronic books to go through purchase processing and return processing and, for a purchased book to be accessed at the reception terminal by handing over bookshelf information and book information on the shop rack, purchase information and return information over a transmission path.

An image to be displayed on the display unit by the service providing unit (4905) will be described below.

This displaying process is held by the service providing function setting unit (4906), and the service providing function executing unit (4907), in compliance with the program, gives a display instruction to the service providing unit (4905).

As the user selects a book displayed on the shop rack, detailed contents of the selected book are displayed.

A display example is shown in FIG. 11. Details are similar to the corresponding description regarding the second embodiment of the invention.

As the user touches the edge of the shop rack, books are slid. A display example is shown in FIG. 14. Details are similar to the corresponding description regarding the second embodiment. Books having newly arrived are stacked flat on the shop rack when they are displayed.

A display example is shown in FIG. 10. Details are similar to the corresponding description regarding the second embodiment. The user performs a purchase operation by acting to shift a book on the shop rack to the user rack.

A display example is shown in FIG. 15. Details are similar to the corresponding description regarding the second embodiment.

If data transmission to the data transmitter fails when a book on the shop rack is to be bought, it will be determined that purchase processing is not yet completed, and the background of books displayed on the screen is differentiated in color at the time of access according to whether or not purchase processing has been completed.

A display example is shown in FIG. 20. Details are similar to the corresponding description regarding the second embodiment.

Further, if purchase processing has not been completed, an account settlement deadline will be set and, if it is over, a warning message will be displayed.

A display example is shown in FIG. 27. Details are similar to the corresponding description regarding the second embodiment.

When a book on the shop rack is to be purchased, if no data can be received from the data transmitter or the book to be purchased is not in the data transmitter, the book can be ordered.

A display example is shown in FIG. 18. Details are similar to the corresponding description regarding the second embodiment. At the time of book access processing, the location of data on the selected product in the storage medium is displayed.

A display example is shown in FIG. 22. Details are similar to the corresponding description regarding the second embodiment.

At the time of book access processing, the access state is displayed on the user rack.

A display example is shown in FIG. 23. Details are similar to the corresponding description regarding the second embodiment.

At the time of book access processing, a password input is displayed to limit access to the user rack.

A display example is shown in FIG. 24.

By shaking the reception terminal at the time of book access processing, the user can enter data, detect and display the page of data he or she wants to access, and receive service.

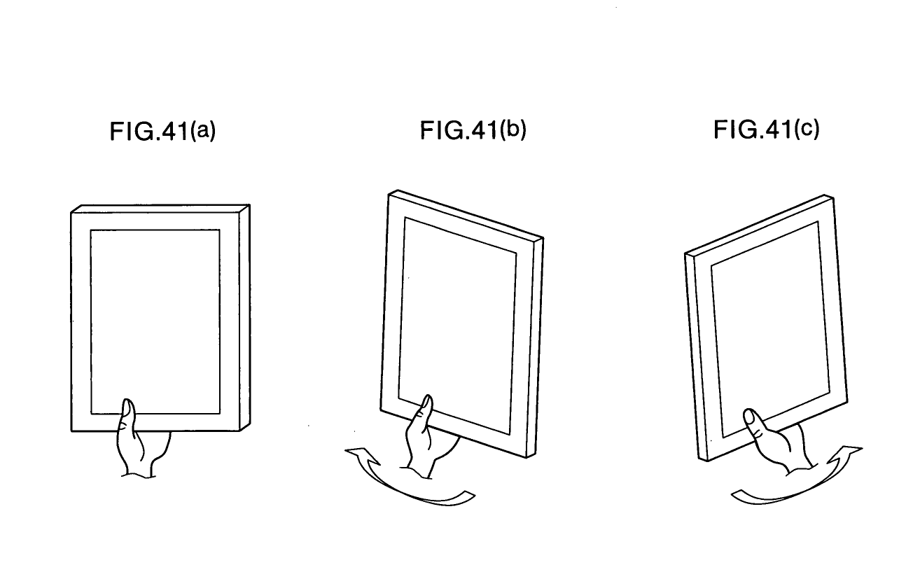

A display example is shown in FIG. 41. Details are similar to the corresponding description regarding the second embodiment.

The reception terminal has a sensor that can sense the shaking of the box, and this sensor can be used to turn the page.

FIG. 41a) shows the state at the time of usual accessing, in which the user is holding part of the box of the reception terminal, and accessing the text of the book displayed on the display unit. The user can turn the page by inclining with his or her wrist the box of the reception terminal being held and returning it to the original position. For instance, if the page is to be turned forward to the next, the user can turn the wrist rightward to incline the box in that direction once as shown in FIG. 41c). Or if turning back to the preceding page is wanted, the user can turn the wrist leftward to incline the box in that direction once as shown in FIG. 41b). In this way, the user can turn the page in either direction by slightly turning the wrist without having to rely on a user interface such as a touch panel or a button.

Or if a plurality of pages are to be turned at a time, the user can keep the wrist turned for some time instead of turning it momentarily. Then, if the user keeps the wrist turned rightward, for instance, the page will continue to be turned forward, or the wrist is kept turned leftward, the page will continue to be turned backward.

If the user keeps on turning the page and returns the box to its original position when the desired page is reached, that page can be accessed. This enables the user in a situation in which the reception can be held and operated by only one hand as in a train or the like, to easily display the desired page.

The third embodiment of the invention, as described so far, can provide, as does the second embodiment, a display method effective for using the service at the reception terminal in a service providing system formed of a transmitter for transmitting data for shop use and a reception terminal.

Although the present invention has been described in specific terms with reference to preferred embodiments thereof illustrated in the accompanying drawings, it should be obvious to persons skilled in the art that the invention can be easily varied or modified without deviating from its essentials. Such alterations, too, will be covered by the scope of the invention.

What is claimed is:

1. A display device having purchased contents and unpurchased contents, further having a screen for displaying a user rack for presenting the purchased contents and a shop rack for presenting the unpurchased contents, provided with an input unit for accepting user operations on any of the contents on said user rack or said shop rack which is displayed, a rack function executing unit for processing any user operation accepted by said input unit, an account settlement managing unit for managing a purchase history and a return history, a rack display executing unit for displaying a screen of said shop rack and said user rack, and a content reproducing unit for reproducing contents.

2. The display device according to claim 1, wherein said rack function executing unit, when it receives from said input unit a request for the purchase of one of the contents on said shop rack, records a purchase history in said account settlement managing unit.

3. The display device according to claim 2, wherein said rack function executing unit determines whether or not to leave the purchase history in said account settlement managing unit according to whether or not the pertinent content is immediately available.

4. The display device according to claim 2, wherein said rack function executing unit, if the content whose purchase has been requested is not immediately available, arranges the content on an ordered book shelf which is on said shop rack or said user rack.

5. The display device according to claim 2, wherein said rack function executing unit, if the content whose purchase has been requested is immediately available, arranges the content on said user rack.

6. The display device according to claim 1, wherein said rack function executing unit, when it has received from said input unit a demand to return one of the contents on said user rack, erases a purchase history of the pertinent content if the purchase history is present in said account settlement managing unit or, if no such purchase history is present, records a return history therein.

7. The display device according to claim 6, wherein said rack function executing unit, in erasing the purchase history from said account settlement managing unit or recording the return history therein, determines from a return condition whether or not the pertinent content is returnable.

8. The display device according to claim 7, wherein said return condition is a certain period of time after the purchase.

9. The display device according to claim 7, wherein said return condition is a certain period of time after reproduction.

10. The display device according to claim 7, wherein said return condition is a certain extent of reproduction done.

11. The display device according to claim 1, wherein said rack display executing unit, responding to a request from said rack function executing unit for displaying summarized information of a content, displays summarized information of the content.

12. The display device according to claim 11, wherein said summarized information includes, where the content is an electronic book, any of the book's title, author's name, publisher, price, issue date and synopsis.

13. The display device according to claim 1, wherein said content reproducing unit, responding to an instruction to preview or an instruction to reproduce the content from said rack function executing unit, executes reproduction processing.

14. The display device according to claim 13, wherein said preview is, where the content is an electronic book, to automatically turn a page after presenting text of the book for a certain period per page.

15. A display device having purchased contents and unpurchased contents, further having a screen for displaying a user rack for presenting the purchased contents and a shop rack for presenting the unpurchased contents, provided with display means for displaying content covers summarizing the contents belonging to said user rack or said shop rack, wherein said display means display the user rack screen and the shop rack screen at the same time.

16. The display device having purchased contents and unpurchased contents, further having a screen for displaying a user rack for presenting the purchased contents and a shop rack for presenting the unpurchased contents according to claim 15, further provided with input means for accepting a user operation done on a displayed screen, wherein said display means display, on a rack display screen where no user operation is done, a screen interlocked with information accepted by said input means.

17. The display device according to claim 16, wherein said display means display, interlocked with an instruction by said input means to select a content cover on the rack display screen, summarized information of the selected content on the rack display screen where the selected content cover is not displayed.

18. The display device according to claim 16, wherein said display means automatically present, interlocked with an instruction by said input means to select a content on the display screen, a preview of the selected content on the screen where the selected content cover is not displayed.

19. The display device according to claim 16, wherein, if content sets in which contents are grouped by category are present on said user rack or shop rack, said display means, interlocked with an instruction by said input means on shelf selection, automatically present content covers on the selected shelf while sliding them.

20. The display device according to claim 15, wherein said display means, if contents on said user rack are periodicals, presents them on a periodical shelf on which they are grouped on the display screen displaying said user rack.

21. The display device according to claim 15, wherein said display means, if contents belonging to said user rack or said shop rack are serial books on the display screen displaying said user rack or shop rack, present only the latest content cover.

22. The display device according to claim 15, wherein said display means, if contents belonging to said user rack or said shop rack are new arrivals, present their covers in an intermittently lit manner on the display screen displaying said user rack or shop rack.

23. The display device according to claim 15, wherein said display means, if contents belonging to said shop rack are electronic books and new arrivals, present their front covers in presenting their covers on the display screen to display said shop rack.

24. The display device having purchased contents and unpurchased contents, further having a screen for displaying a user rack for the presenting purchased contents and a shop rack for presenting the unpurchased contents according to claim 16, further provided with account settlement managing means for managing a purchase history and a return history, wherein said account settlement managing means instruct an operation to purchase the content on said shop rack accepted by said input means and manage recording of the purchase history and the return history according to an instruction to operate for a return of one of the contents on said user rack.

25. The display device according to claim 24, wherein said display means, interlocked with a user instruction with said input means to operate a content purchase on the display screen of said shop rack, display on said user rack the cover of a content for which the purchase operation has been done.

26. The display device according to claim 25, wherein said display means vary the screen to be displayed according to whether or not the content for which a user has done a purchase operation is available for immediate reproduction.

27. The display device according to claim 25, wherein said display means, if the content for which the user has done a purchase operation is not available for immediate reproduction, display the content on an ordered book shelf which is grouped on the user rack or the shop rack.

28. The display device according to claim 25, wherein said display means, when the user operates for a purchase, display a password input screen in order to determine whether or not to permit the purchase.

29. The display device for displaying information according to claim 24, further provided with reproducing means for reproducing contents belonging to said user rack, said reproducing means responding to a user operation with said input means to purchase a content, and processing reproduction of the purchased content.

30. The display device according to claim 29, wherein said reproducing means, in reproducing a content on said user rack, change a reproducing method if the content has not yet undergone account settlement, i.e. it is not recorded in an account settlement processing server for processing account settlement for the purchase history managed by said account settlement managing means.

31. The display device according to claim 30, wherein said reproducing means, if the content is an electronic book, change a background of text in displaying it.

32. The display device according to claim 25, wherein said display means, if the content on said ordered book shelf becomes reproducible, change the cover of said content in displaying it.

33. The display device according to claim 25, wherein said display means, if the content on said ordered book shelf is not yet introduced to the market, display its scheduled issue date on the cover of said content.

34. The display device according to claim 25, wherein said display means, if the content on said ordered book shelf is not yet introduced to the market, display the number of days until its scheduled issue date on the cover of said content.

35. The display device according to claim 25, wherein said display means display, interlocked with a user instruction with said input means to operate a content return on said user rack display screen, said user rack from which the cover of the returned cover is erased.

36. The display device according to claim 24, wherein said input control unit, if a return condition is attached said purchased content, vary the display instructed to the display means according to a result of evaluation against the condition.

37. The display device having purchased contents and unpurchased contents, further having a screen for displaying a user rack for presenting the purchased contents and a shop rack for presenting the unpurchased contents according to claim 29, further provided with utilization managing means for managing a state of utilization of contents on said user rack, wherein said utilization managing means manage information on utilization according to an instruction accepted by said input means to operate for reproduction of one of the contents on said user rack.

38. The display device according to claim 37, wherein the information on utilization managed by said utilization managing means comprise the purchase day/hours, access start/end day/hours and a previous end point of the utilized content.

39. The display device according to claim 15, wherein said display means, if the display of a content cover on said user rack or said shop rack indicates that the content is not reproducible by the display device, displays information indicating a location of the content.

40. The display device according to claim 37, wherein said display means determines the state of utilization of contents on said user rack on the basis of the information on utilization managed by said utilization managing means, and changes each content cover according to the state of utilization.

41. The display device according to claim 29, wherein said reproducing means process reproduction of the contents on said user rack in response to an instruction by said input means to operate reproduction of the contents on said user rack.

42. The display device according to claim 41, wherein said display means display a password input screen for determination as to whether or not to permit reproduction in response to an instruction by said input means to operate reproduction of the contents on said user rack.

43. The display device according to claim 16, wherein said display means, when one of the contents on said user rack or said shop rack has been selected by said input means, displays incidental information related to the content.

44. The display device according to claim 43, wherein said incidental information is new episode announcement information where the contents are part of a series.

45. The display device according to claim 24, wherein said input means compute duration of an account remaining unsettled from the purchase history managed by said account settlement managing means and current time, instruct said display control unit to present information notifying a function stop if the account is found to have remained unsettled for a certain period of time or longer, and no longer accept any operational input from the user thereafter.

46. A service providing system for transmitting and receiving data over a transmission path, wherein a data transmitter of said service providing system has a shop function setting unit capable of setting such functions as a method of displaying information and the kind of service to be provided and a shop function executing unit for executing and processing a function set by said shop function setting unit; further a reception terminal for receiving data from said data transmitter has a service providing unit for executing a display or a function according to said received data; a service providing function setting unit capable of setting a function for providing a unique service at said reception terminal; a service providing function executing unit for executing and processing the function set by said service providing function setting unit; and a user data input/output unit for accepting input data from a user when said function is to be executed by said service providing function executing unit and transmitting and receiving data to be used for executing said function, and said service providing unit being capable of providing service combining the function set in said shop function setting unit and the function set in said service providing function setting unit.

47. The service providing system for transmitting and receiving data over a transmission path according to claim 46, wherein service is provided in said service providing unit of the reception terminal of said service providing system by displaying showcase racks of a retail store.

48. The service providing system for transmitting and receiving data over a transmission path according to claim 46, wherein service is provided in said service providing unit of the reception terminal of said service providing system by not only displaying the showcase racks of the retail store but also enabling, as the user selects any of the products displayed on said showcase racks, detailed contents of said selected product to be displayed.

49. The service providing system for transmitting and receiving data over a transmission path according to claim 46, wherein service is provided in said service providing unit of the reception terminal of said service providing system by not only displaying the showcase racks of the retail store but also enabling said showcase racks to be turned to display products as the user touches said showcase racks.

50. The service providing system for transmitting and receiving data over a transmission path according to claim 46, wherein service is provided in said service providing unit of the reception terminal of said service providing system by enabling display of products that have newly arrived to be stacked flat on the showcase racks of the retail store.

51. The service providing system for transmitting and receiving data over a transmission path according to claim 46, wherein the showcase racks of the retail store and a user product shelf which is the user's own shelf are displayed, service of a data input by the user at said user data input/output unit to shift a product displayed on a showcase rack of the retail stored to said user product shelf is provided in said service providing unit of the reception terminal of said service providing system.

52. The service providing system for transmitting and receiving data over a transmission path according to claim 46, wherein service is provided in said service providing unit of the reception terminal of said service providing system, at the time of processing an account of a product purchase by the user's data input at said user data input/output unit, by displaying whether or not the account settlement has been completed on the screen by differentiation in color.

53. The service providing system for transmitting and receiving data over a transmission path according to claim 46, wherein service is provided in said service providing unit of the reception terminal of said service providing system, at the time of processing the account of a product purchase by the user's data input at said user data input/output unit, by displaying a warning message if the account settlement is behind its deadline.

54. The service providing system for transmitting and receiving data over a transmission path according to claim 46, wherein service is provided in said service providing unit of the reception terminal of said service providing system, at the time of processing a product purchase by the user's data input at said user data input/output unit, by enabling an advance purchase order to be placed.

55. The service providing system for transmitting and receiving data over a transmission path according to claim 46, wherein service is provided in said service providing unit of the reception terminal of said service providing system, at the time of processing a product purchase order by the user's data input at said user data input/output unit, by enabling the product ordered for purchase to be returned.

56. The service providing system for transmitting and receiving data over a transmission path according to claim 46, wherein service is provided in said service providing unit of the reception terminal of said service providing system, at the time of processing accessing information on a product by the user's data input at said user data input/output unit, by displaying a location of data on the selected product.

57. The service providing system for transmitting and receiving data over a transmission path according to claim 51, wherein service is provided in said service providing unit of the reception terminal of said service providing system, at the time of processing accessing information on a product by the user's data input at said user data input/output unit, by displaying an accessed state on said user product shelf.

58. The service providing system for transmitting and receiving data over a transmission path according to claim 51, wherein service is provided in said service providing unit of the reception terminal of said service providing system, at the time of processing accessing information on a product by the user's data input at said user data input/output unit, by displaying a password input to limit access to products on said user product shelf.

59. The service providing system for transmitting and receiving data over a transmission path according to claim 46, wherein service is provided in said service providing unit of the reception terminal of said service providing system, at the time of processing accessing information on a product by the user's data input at said user data input/output unit, by enabling the user to input data by shaking said reception terminal and thereby to detect and display a page of data the user desires to access.

60. A service providing system for transmitting and receiving data over a transmission path wherein a data transmitter of said service providing system has a shop function setting unit for setting such functions as a method of displaying information and the kind of service to be provided and a shop function executing unit for executing and processing a function set by said shop function setting unit.

61. A service providing system for transmitting and receiving data over a transmission path wherein a reception terminal of said service providing system has a service providing unit for executing a display or a function corresponding to received data; a service providing function setting unit capable to setting a function for providing unique service at said reception terminal; a service providing function executing unit for executing and processing the function set by said service providing function setting unit; and a user data input/output unit for accepting, when said function is executed by said service providing function executing unit, input data from a user and transmitting/receiving data for use in the execution of said function, wherein said service providing unit can provide service combining a function to set such functions as a method of displaying information and the kind of service to be provided and the function set in said service providing function setting unit.

62. The service providing system for transmitting and receiving data over a transmission path according to claim 61, wherein service is provided in said service providing unit of the reception terminal of said service providing system by displaying showcase racks of a retail store.

63. The service providing system for transmitting and receiving data over a transmission path according to claim 61, wherein service is provided in said service providing unit of the reception terminal of said service providing system by not only displaying the showcase racks of the retail store but also enabling, as the user selects any of the products displayed on said showcase racks, detailed contents of said selected product to be displayed.

64. The service providing system for transmitting and receiving data over a transmission path according to claim 61, wherein service is provided in said service providing unit of the reception terminal of said service providing system by not only displaying the showcase racks of the retail store but also enabling said showcase racks to be turned to display products as the user touches said showcase racks.

65. The service providing system for transmitting and receiving data over a transmission path according to claim 61, wherein service is provided in said service providing unit of the reception terminal of said service providing system, at the time of processing accessing information on a product by the user's data input at said user data input/output unit, by enabling the user to input data by shaking said reception terminal and thereby to detect and display a page of data the user desires to access.

66. A service providing method for transmitting and receiving data over a transmission path, wherein a data transmitter in said service providing method has a step of making possible setting of such functions as a method of displaying information and the kind of service to be provided and a step of executing and processing said set function.

67. A service providing method for transmitting and receiving data over a transmission path, wherein a reception terminal in said service providing method has a step of executing a display or a function corresponding to received data; a step of making possible setting of a function for providing unique service at said reception terminal; a step of executing and processing said set function; a step of accepting input data from a user when said function is to be executed; a step of transmitting/receiving data for use in the execution of said function; and a step of making possible provision of service combining a function to set such functions as a method of displaying information and the kind of service to be provided and said set function.

68. The service providing method for transmitting and receiving data over a transmission path according to claim 67, further having a step of displaying showcase racks of a retail store and a step of providing service.

69. The service providing method for transmitting and receiving data over a transmission path according to claim 67, further having a step of not only displaying the showcase racks of the retail store but also enabling the user to select any of the products displayed on said showcase racks, a step of displaying detailed contents of said selected product, and a step of providing service.

70. The service providing method for transmitting and receiving data over a transmission path according to claim 67, further having a step of not only displaying the showcase racks of the retail store but also enabling said showcase racks to be turned to display products as the user touches said showcase racks, and a step of providing service.

71. A recording medium in which is recorded a service providing program for transmitting and receiving data over a transmission path, wherein a data transmitter in said service providing program has a step of making possible setting of such functions as a method of displaying information and the kind of service to be provided and a step of executing and processing said set function.

72. A recording medium in which is recorded a service providing program for transmitting and receiving data over a transmission path, wherein a reception terminal in said service providing program has a step of executing a display or a function corresponding to received data; a step of making possible setting of a function for providing unique service at said reception terminal; a step of executing and processing said set function; a step of accepting input data from a user when said function is to be executed; a step of transmitting/receiving data for use in the execution of said function; and a step of making possible provision of service combining a function to set such functions as a method of displaying information and the kind of service to be provided and said set function.

73. The recording medium in which is recorded a service providing program for transmitting and receiving data over a transmission path according to claim 72, further having a step of displaying showcase racks of a retail store and a step of providing service.

74. The recording medium in which is recorded a service providing program for transmitting and receiving data over a transmission path according to claim 72, further having a step of not only displaying the showcase racks of the retail store but also enabling the user to select any of the products displayed on said showcase racks, a step of displaying detailed contents of said selected product, and a step of providing service.

75. The recording medium in which is recorded a service providing program for transmitting and receiving data over a transmission path according to claim 72, further having a step of not only displaying the showcase racks of the retail store but also enabling said showcase racks to be turned to display products as the user touches said showcase racks, and a step of providing service.

76. A service providing program for transmitting and receiving data over a transmission path, wherein a data transmitter in said service providing program causes a computer to execute a step of making possible setting of such functions as a method of displaying information and the kind of service to be provided and a step of executing and processing said set function.

77. A service providing program for transmitting and receiving data over a transmission path, wherein a reception terminal in said service providing program causes a computer to execute a step of executing a display or a function corresponding to received data; a step of making possible setting of a function for providing unique service at said reception terminal; a step of executing and processing said set function; a step of accepting input data from a user when said function is to be executed; a step of transmitting/receiving data for use in the execution of said function; and a step of making possible provision of service combining a function to set such functions as a method of displaying information and the kind of service to be provided and said set function.

78. The service providing program for transmitting and receiving data over a transmission path according to claim 77, to cause a computer to execute a step of displaying showcase racks of a retail store and a step of providing service.

79. The service providing program for transmitting and receiving data over a transmission path according to claim 77, to cause a computer to execute a step of not only displaying the showcase racks of the retail store but also enabling the user to select any of the products displayed on said showcase racks, a step of displaying detailed contents of said selected product, and a step of providing service.

80. The service providing program for transmitting and receiving data over a transmission path according to claim 77, to cause a computer to execute a step of not only displaying showcase racks of the retail store but also enabling said showcase racks to be turned to display products as the user touches said showcase racks, and a step of providing service.
